(19) United States
(12) Patent Application Publication
(10) Pub. No.: US 2006/0066803 A1
(43) Pub. Date: Mar. 30, 2006

(54) Substrate free flexible liquid crystal displays

(76) Inventors: Peter T. Aylward, Hilton, NY (US); Erica N. Montbach, Pittsford, NY (US)

Correspondence Address: Paul A. Leipold;Patent Legal Staff, Eastman Kodak Company, 343 State Street, Rochester, NY, 14650-2201, US

(21) Appl. No.: 10/954,722

(22) Filed: Sep. 30, 2004

(51) Int. Cl. G02F 1/1333

(52) U.S. Cl. 349/158

(57) ABSTRACT

The present invention relates to a flexible multi-color display comprising an optional substrate, at least one independently switchable electrically modulated imaging layer between an upper conductive layer and a lower conductive layer, wherein the number of said optional substrate is less than or equal to the number of said at least one independently switchable electrically modulated imaging layer. The present invention also relates to a display comprising portions of a flexible multi-color displays produced separately and laminated to gether to form a final display, as well as displays having removable carrier/transport substrates and methods for making the same.

### FIELD OF THE INVENTION

The present invention relates to full color electrochromic and chiral doped cholesteric liquid crystal displays their design and method of making.

### BACKGROUND OF THE INVENTION

Cholesteric displays are bistable in the absence of a field, the two stable states being the reflective planar state and the weakly scattering focal conic state. In the planar state, the helical axes of the cholesteric liquid crystal molecules are substantially parallel to the substrates between which the liquid crystal is disposed. In the focal conic state the helical axes of the liquid crystal molecules are generally randomly oriented. By adjusting the concentration of chiral dopants in the cholesteric material, the pitch length of the molecules and thus, the wavelength of radiation that they will reflect, can be adjusted. Cholesteric materials that reflect infrared radiation have been used for purposes of scientific study. Commercial displays are fabricated from cholesteric materials that reflect visible light.

A liquid crystal display device includes a chiral nematic liquid crystal material in a droplet or domain which has a margin or wall structure surrounding the droplet or domain. The domain wall structure and the liquid crystal cooperate to form focal conic and twisted planar states that are stable in the absence of a field. A device applies an electric field to the liquid crystal for transforming at least a portion of the material to at least one of the focal conic and twisted planar states. The liquid crystal material has a pitch length effective to reflect radiation having a wavelength in both the visible and the infrared ranges of the electromagnetic spectrum at intensity that is sufficient for viewing by an observer. One liquid crystal material may be disposed in a single region or two or more liquid crystal materials may be used, each in separate regions with or without an infrared reflecting layer. One aspect of the invention is directed to a numbers of layers and substrates to make a full-color display.

In U.S. Pat. No. 6,654,080 Khan et al describe a stacked full color display utilizing three separate chiral nematic liquid materials in which glass substrates are placed between each color. The domains disclosed in this invention are liquid filled cells and must be sealed to prevent them from leaking. In the formation of displays with more than one color, the means of making the displays while improved over prior art requires n+1 substrates (n=number of colors). While such a displays are useful, the use of several very stiff or nonflexible substrates makes this device only useful for flat applications. Additionally such a display has numerous surface interfaces that can cause light scattering and absorption that reduces the overall efficiency of the light exiting the display. The contrast ratio between the background and image will be reduced. Therefore customer will find this display less attractive. There remains a need for improved displays.

In U.S. Pat. No. 6,278,505 Okada discloses a liquid crystal reflective display comprising cholesteric liquid crystal capable of selectively reflecting spectral rays of a specific wavelength in a visible range; and a carrier carrying said cholesteric liquid crystal, wherein at least one of said cholesteric liquid crystal and said carrier contains a coloring agent absorbing spectral rays in a wavelength range different from the selective reflection wavelength of said cholesteric liquid crystal. Such a display requires two support substrates to form an active assembled display cell. Such displays suffer from low reflectivity because of the large number of substrate interfaces. Any mismatch in refractive index is compounded at each interface. Additionally, such displays are very rigid and therefore not very flexible. There remains a need for an improved display with fewer layers of substrate.

U.S. Pat. Nos. 6,433,843 and 6,320,631 describes a liquid crystal reflective display comprising cholesteric liquid crystal capable of selectively reflecting spectral rays of a specific wavelength in a visible range; and a substrate with a cholesteric liquid crystal, wherein at least one of said cholesteric liquid crystal and said substrate with a coloring agent absorbing spectral rays in a wavelength range different from the selective reflection wavelength of said cholesteric liquid crystal. In this there are at least two different substrates required fro each color in the display. Such a display suffers from being very rigid and suffers from reduced optical clarity because of the large number of layer interfaces.

In U.S. Pat. No. 5,453,863 a display with a light modulating reflective domain comprising a polymer free chiral nematic liquid crystalline light modulating material is disclosed. The domain includes nematic liquid crystal having positive dielectric anisotropy and chiral material in an amount effective to form focal conic and twisted planar states. The chiral material has a pitch length effective to reflect light in the visible spectrum, wherein the focal conic and twisted planar states are stable in the absence of a field and the liquid crystal material is capable of changing states upon the application of a field. In this patent the assembled display cells are liquid filled with edge seals. In order to form a display with more than one color, individual assembled display cells are epoxide together. Each assembled display cells requires at least two substrates in order to form the display and therefore suffers from being not being flexible and also having numerous interface layers that will scatter light and reduces the displays overall efficiency. There remains a need for a better display.

U.S. Pat. No. 6,580,482 provides a reflective type multi-color display device is capable of obtaining a multi-color display with less display layers, and therefore, with a state where a parallax is decreased and a cost of the device can be reduced. Specifically, the display device includes a assembled display cell having a display layer comprising a right-handed cholesteric liquid crystal which selects and reflects blue, a assembled display cell having a display layer comprising a left-handed cholesteric liquid crystal which selects and reflects green, a assembled display cell having a display layer comprising a right-handed cholesteric liquid crystal which selects and reflects yellow and a assembled display cell having a display layer comprising a left-handed cholesteric liquid crystal which selects and reflects red, these layers being laminated in this order from the observation side. A color filter that transmits red and absorbs the other color light is provided between the assembled display cell and specifically in the liquid crystal/binder layer. A black light absorbing layer is formed at the back side of the assembled display cell. Such a display also requires at least two substrates for each for each color and therefore suffers from the same problems as other full color displays. In one example within this patent, three separate layers of liquid are disposed adjacent to each other with no means of controlling each individual color. While this display can produce color and has one less substrate, it cannot modulate each layer individually and therefore has limited use. There remains a need for an improve display.

In U.S. Pat. No. 6,468,378 Hannington describes a means of making a light-transmitting filter that comprises a light-absorbing layer in which microspheres are embedded. The microspheres act as a light tunnel to form a projection screen in which light information from an external source is transmitted through the layers to form an image on the outer surface. In the method of making this projection screen, a layer of the microspheres as a separate layer are coated onto a release sheet and then subsequently removed and adhesively laminated to another material such as glass or plexiglass. This process is designed for projection screen and contains any electrically modulated layers and therefore has limited usefulness for liquid crystal displays.

In U.S. Pat. Nos. 6,278,505, 6,320,631 and 6,433,843 discloses an embodiment in which there is an upper and lower surface formed by substrates containing cholesteric crystals in a matrix of resin. The term “lower” or “bottom” as used herein shall mean the side closest to the viewing side of the liquid crystal display. “Upper” or “top” shall mean the side away from the side through which the functional image is viewed. It is mentioned in passing that if the amount of resin is significantly increased that the substrates may not be needed. By increasing the amount of resin, the layers become thicker and therefore the electrical drive voltage of the display will be greatly increased. Approximately 10 volts/additional micron of thickness is need but there is a limit or the displays will not be functional. Such displays will require very high voltages to switch and will be subject to burnouts and shorts. Additionally the thicker layers of rein may further result in light scattering and less efficient displays. There is a need for a display with fewer substrates that do not suffer from poor electrical performance and optical performance. If the amount of resin and liquid crystal is increased to provide a minimum amount of display stiffness, the liquid crystal layer become prohibitively expensive for a cost effective display. Most polymers suitable for use in a liquid crystal layer do not have very high modulus of elasticity and therefore are not efficient means for eliminating substrates. There is a need for electrically modulating display that can be made with low stiffness, improved optical performance and efficient or low voltage requirements.

### Problem to be Solved

There remains a need for light efficient, flexible displays.

### SUMMARY OF THE INVENTION

The present invention relates to a flexible multi-color display comprising an optional substrate, at least one independently switchable electrically modulated imaging layer between an upper conductive layer and a lower conductive layer, wherein the number of optional substrates is less than or equal to the number of independently switchable electrically modulated imaging layers. The present invention also relates to a display comprising a top part having an upper and lower layer and a bottom part having an upper and lower layer, wherein the lower layer of the top part and the upper layer of the bottom part are laminated together, wherein the top part comprises an upper substrate layer and a lower conductive layer and wherein the bottom part comprises an upper liquid crystal layer, a lower transparent substrate layer, and a conductive layer between the upper liquid crystal layer and said lower transparent substrate layer. The present invention also includes a coated display comprising at least one coated liquid crystal assembled display cell, wherein the liquid crystal assembled display cell comprises a coated transparent conductive layer, a black etched conductor coated onto a substrate that is not in the active view plane of the display, and a liquid crystal layer coated between the transparent conductive layer and the black etched conductor. The present invention also relates to a coated display comprising a substrate that is not in the active view plane of the display, a black conductive layer coated thereon, a third liquid crystal layer coated on the side of the black conductive layer opposite the substrate, a fifth conductive layer coated on the side of the third liquid crystal layer opposite the black conductive layer, a second dielectric insulating layer coated on the side of the fifth conductive layer opposite the third liquid crystal layer, a fourth conductive layer coated on the side of the second dielectric insulating layer opposite the fifth conductive layer, a second liquid crystal layer coated on the side of the fourth conductive layer opposite the second dielectric insulating layer, a third conductive layer coated on the side of the second liquid crystal layer opposite the fourth conductive layer, a first dielectric insulating layer coated on the side of the third conductive layer opposite the second liquid crystal layer, a second conductive layer coated on the side of the first dielectric insulating layer opposite the third conductive layer, a first liquid crystal layer coated on the side of the second conductive layer opposite the first dielectric insulating layer, and a first conductive layer coated on the side of the first liquid crystal layer opposite the second conductive layer, as well as a method of forming a flexible multi-color display comprising providing a removable substrate; and applying at least one independently switchable light modulating layer between an upper conductive layer and a lower conductive layer, wherein the number of substrates is less than or equal to the number of modulating layers, and a method of forming a flexible multi-color display comprising providing a substrate and applying an upper patterned conductive layer thereto to form an upper display portion; providing a transparent substrate and applying a lower patterned conductive layer followed by an electrically modulate imaging layer thereto to form a lower display portion; and laminating the upper display portion to the lower display portion.

### ADVANTAGEOUS EFFECT OF THE INVENTION

The present invention includes several advantages, not all of which are incorporated in a single embodiment. The present invention provides an “all coated” approach to making a liquid crystal, without the need for a support. The display may be formed on a transport sheet, which may also be referred to as a carrier sheet or substrate, or release liner and then transferred to an article, such as a supporting panel, that may be flat or shaped. This may allow for the formation of conformal displays. This invention does not require the use of a substrate and furthermore provides improved flexibility regarding where and how such displays can be used. Since this invention does not have a substrate, it may be used as a flat display or it may be formed in a curved or irregular shape. Such a display has expanded utility and use in a number of novel applications. Electronic displays can be used and conformed to a variety of articles that otherwise are not possible when thick, stiff substrates are used. The present invention also provides several display architectures in which there are a reduced number of layers and thereby improves the overall efficiency of the displays.

### BRIEF DESCRIPTION OF THE DRAWINGS

FIG. 1 is a cross section of a typical single color liquid crystal display.

FIG. 2 is a cross section of two separate webs that are used to make a typical single color liquid crystal display.

FIG. 3 is a cross section of three liquid assembled display cells prior to being adhered to each other.

FIG. 4 is a cross section of a stacked three-color display.

FIG. 5 is a cross section of one embodiment of this invention in which one support substrate is removed from the usable part of the display.

FIG. 6 is a cross section of an embodiment of this invention, in which there are only three substrates required to make a three-color display.

FIG. 7 is a cross section of an embodiment of this invention in which there a two substrates required for a three color display.

FIG. 8 is a cross section of another embodiment of the invention in which there is only one substrate required for a three-color display.

FIG. 9 is a cross section of another embodiment of this invention in which only one substrate is required for a three-color display.

FIG. 10 is a cross section of another embodiment of this invention in which only one substrate is required for a three-color display.

FIG. 11 is a cross section of another embodiment of this invention in which there is no substrate in the active viewing part of the display.

FIG. 12 is a cross sections of yet another embodiment of this invention where is no substrate in any part of the display.

FIG. 13 is a cross section of another embodiment of the present invention where there is no substrate in any part of the display.

FIG. 14 illustrates a Lambertian distribution, which is a sum of reflections in all directions.

### DETAILED DESCRIPTION OF THE INVENTION

In the formation of reflective full color liquid crystal displays that contain red, green and blue colors or combinations and variants of these primary colors, the typical process requires the formation of individual assembled display cells for each color to be placed in the display and then adhering these assembled display cells in a stack by using adhesives.

The term “assembled display cells” shall refer to the layers of conductors, liquid crystal and substrate that are required to provide a switchable liquid crystal display. Each typical assembled display cell of the prior art has a substrate and an etched highly conductive layer, a coating of liquid crystal and a means of providing a second highly conductive electrode on top of the liquid crystal or other means for inducing an electrical field across the liquid crystal layer. Such stacks of assembled display cells have been reported to contain a minimum of three or more substrates. Very often it may require six substrates or more and the total display may have over twenty layers. The inventive assembled display cells contain at minimum the layers of conductors and liquid crystal that are required to provide a switchable liquid crystal display. Each typical assembled display cell of the invention has an etched highly conductive layer, a coating of liquid crystal and a means of providing a second highly conductive electrode on top of the liquid crystal or other means for inducing an electrical field across the liquid crystal layer. Any substrate is optional.

The light efficiency of such a conventional device of the prior art decreases with each layer. Light is absorbed, scattered or transmitted within each material or at each surface interface. Since each layer has two surfaces, it is easily seen that the light efficient of such display is very low. Unless each layer is matched for refractive index, the light loss can be very high and since these displays are reflective and have no internal light source, light must pass through each layer twice before being viewable by the observer. Such displays are easily less than 30-40% efficient. Another problem is that displays with so many layers and substrates become very stiff and nonflexible. Such displays are not very conformal and have limited use. Many of the displays in the prior art are coated on glass and the liquid crystal layers are encapsulated domains that contain fluid. Such displays have limited usefulness and are not flexible.

Typically LC displays are formed on a substrate such as glass or flexible plastic. For color displays, there is usually at least one substrate per color to make the display. The substrates usually have a thickness of 2-7 mils or more. When light passes through these layers it is transmitted, absorbed, reflected or otherwise scattered. This results in lower overall efficiency and loss of light in the display. This invention relates to forming at least one or more color assembled display cells of liquid crystal, with conductive layers on each side of each color with less than one substrate per color. A dielectric insulating material may be needed to separate the colored assembled display cells to prevent shorting between electrodes of different assembled display cells.

For purposes of the present invention, the display will be described as liquid crystal display. However, it is envisioned that the present invention may find utility in a number of other applications, such as the formation of passive reflective color and monochromatic displays.

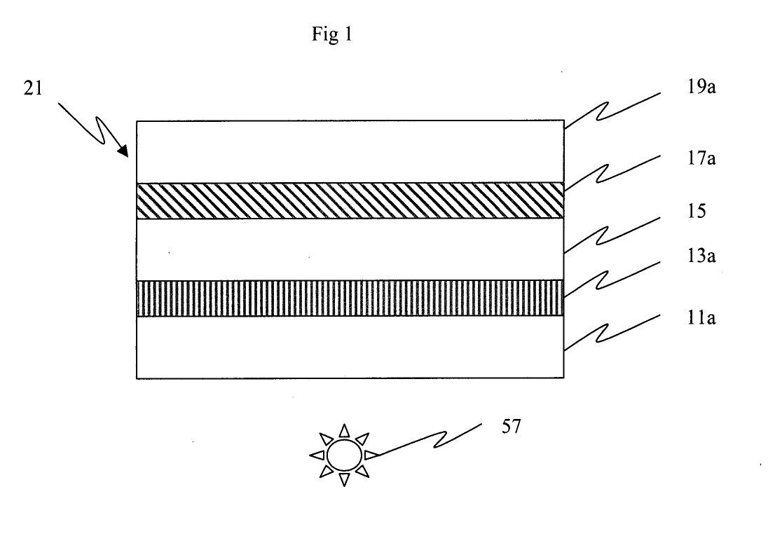

The invention may be further understood by reference to the attached figures. FIG. 1 is a typical cross section of a single color liquid crystal display 21 that is made up of transparent substrate 11a, transparent conductor 13a, first liquid crystal/binder layer 15, a second conductor 17a and top substrate 19a. When a voltage field is applied to conductors 13a and 17a, it is possible to switch the liquid crystal between focal conic and planar states and thereby change the transmissivity and reflective properties of display 21. FIG. 1 is a reflective display and is illuminated with light source 57 and it is viewed from the illumination side. Such an assembled display cell structure is well known in the art. For purposes of the present invention, the “bottom” of the display, as well as the “bottom” layers and “bottom” parts are defined as being those parts and layers closest to the viewer.

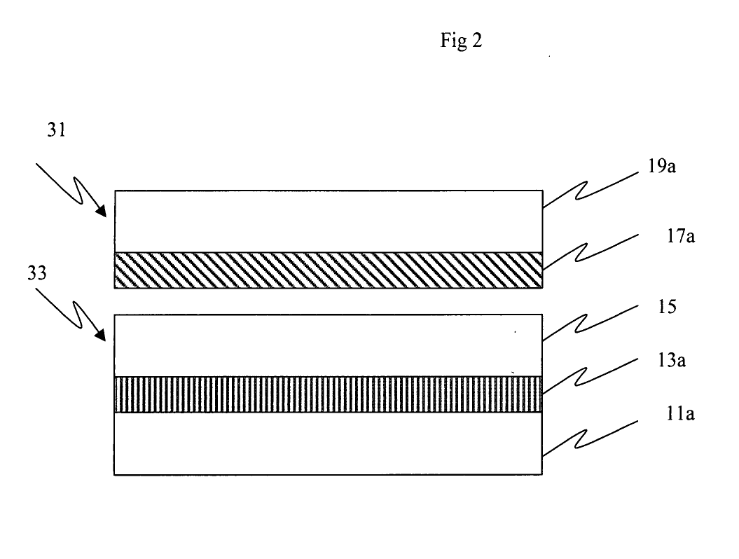

FIG. 2 is two separate substrates required to make this display in FIG. 1. FIG. 2 is a convenient means of attaching a top electrode containing substrate 31 that is made up of a substrate 19a and conductive layer 17a to the bottom liquid crystal containing substrate 33 that is made up of transparent substrate 11a, conductive layer 13a and liquid crystal/binder layer 15. The two substrates 31 and 33 are laminated together to form FIG. 1.

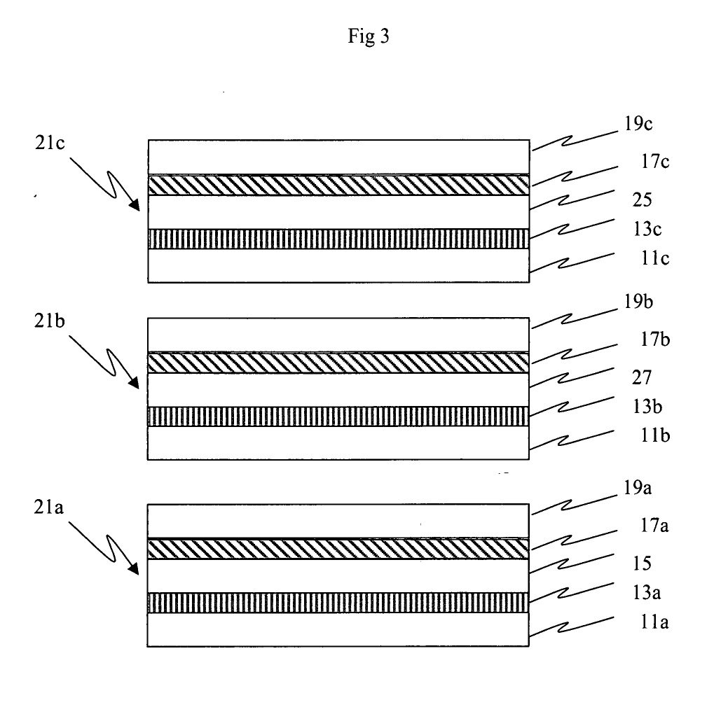

FIG. 3 comprises unattached assembled display cell 21a which is the first liquid crystal assembled display cell with substrate 11a, bottom conductive layer 13a, first liquid crystal layer 15, top conductive layer 17a and top substrate 19a; 21b which is the first liquid crystal assembled display cell with substrate 11b, bottom conductive layer 13b, second liquid crystal layer 27, top conductive layer 17b and top substrate 19b; 21c which is the third liquid crystal assembled display cell with substrate 11c, bottom conductive layer 13c, third liquid crystal layer 25, top conductive layer 17c and top substrate 19c. At this point the assembled display cells are shown in relative order of stacking before they are adhered together.

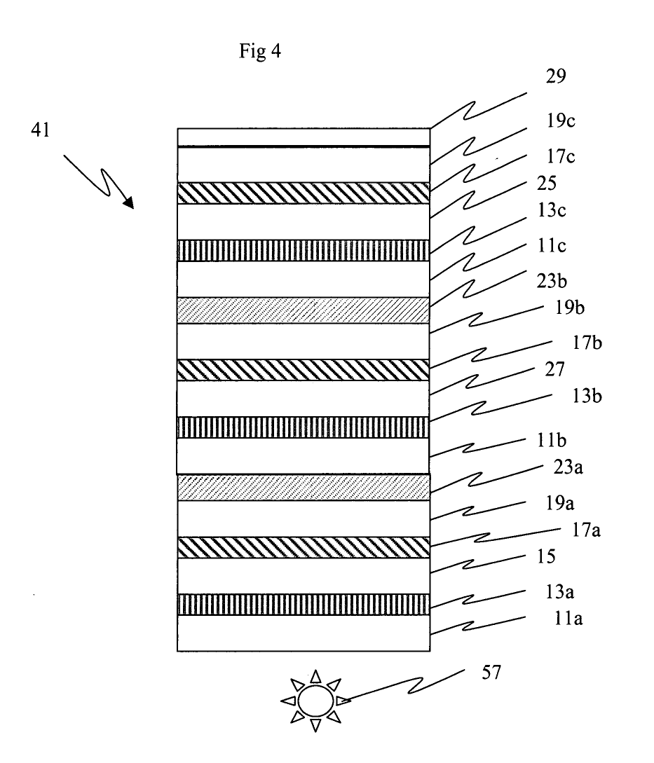

When more than one color is desired in a liquid crystal display three assembled display cells of different colors are stacked and glued together as shown in FIG. 4. A typical three-color display 41 further comprises the three display assembled display cells as shown in FIG. 3 adhered together with an adhering material 23a and 23b. The construction in this display has a minimum number of eighteen layers.

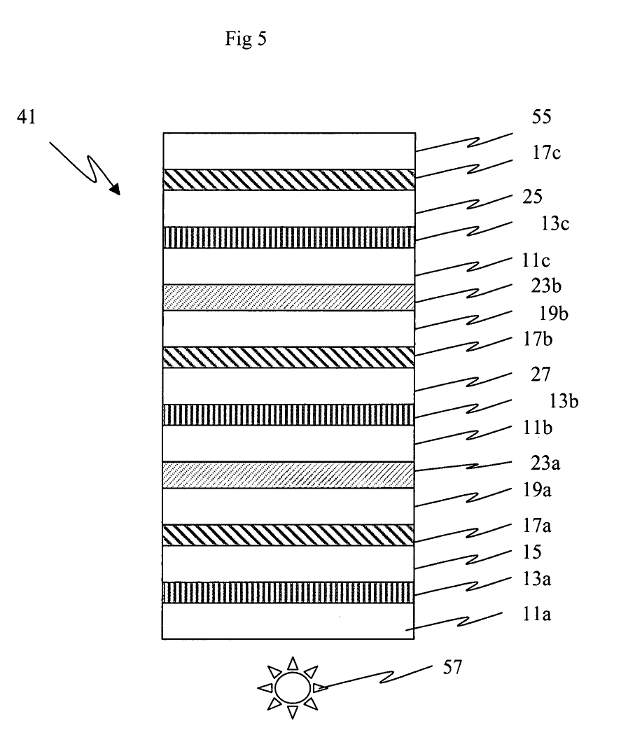

As noted in FIG. 5 a minimum of seventeen layers are required to make this display functional. The difference between FIG. 4 and FIG. 5 is that the layers 29 and 19c of FIG. 4 are replaced with an etched or printed black conductor 55. The etched conductor is a means of creating a pixelized display by etching a pattern, typically a series of a parallel fine lines, in the bottom conductor of a display assembled display cell and a pattern, typically a series of fine lines at an angle to those of the bottom etched lines, in the top conductor. Such a configuration allows individual pixels to be addressed.

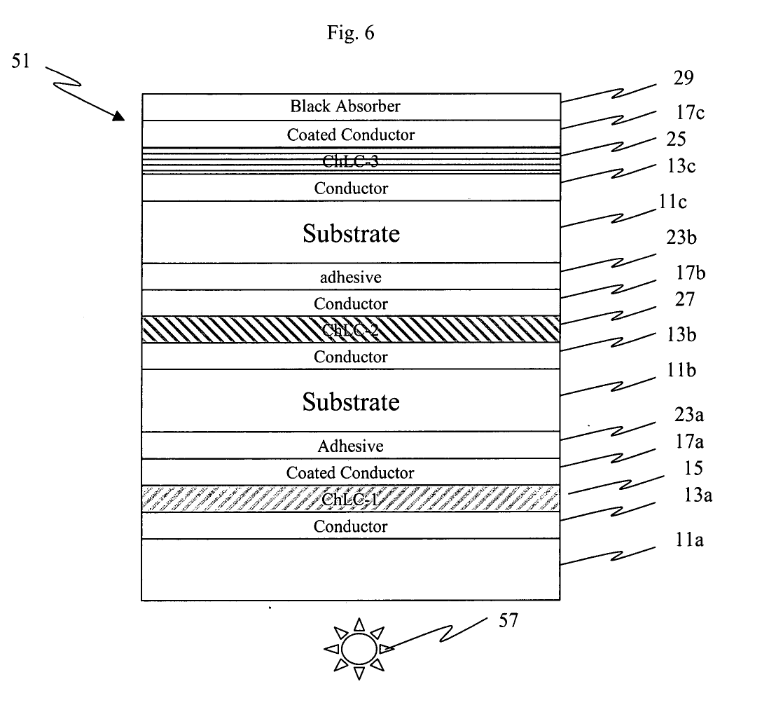

FIG. 6 is a cross section of one embodiment of this invention with a reduced numbers of layers (15) as compared with three color display 41 of FIG. 5 in which the minimum number of layers is 17. As noted there are only three transparent substrates versus six as shown in FIG. 5. Such a display comprises three transparent substrates 11a, 11b, 11c, three bottom transparent conductive layers 13a, 13b, 13c three top conductive layer 17a, 17b, and 17c that are coated respectively with one of the liquid crystal layers 15, 27 and 25. FIG. 6 additionally has two adhesive layer 23a and 23b to adhered the individual colored assembled display cells together. A black or otherwise colored light absorber layer 29, also referred to as a color contrast layer, is coated on top of the third top electrode associated with the third liquid crystal layer.

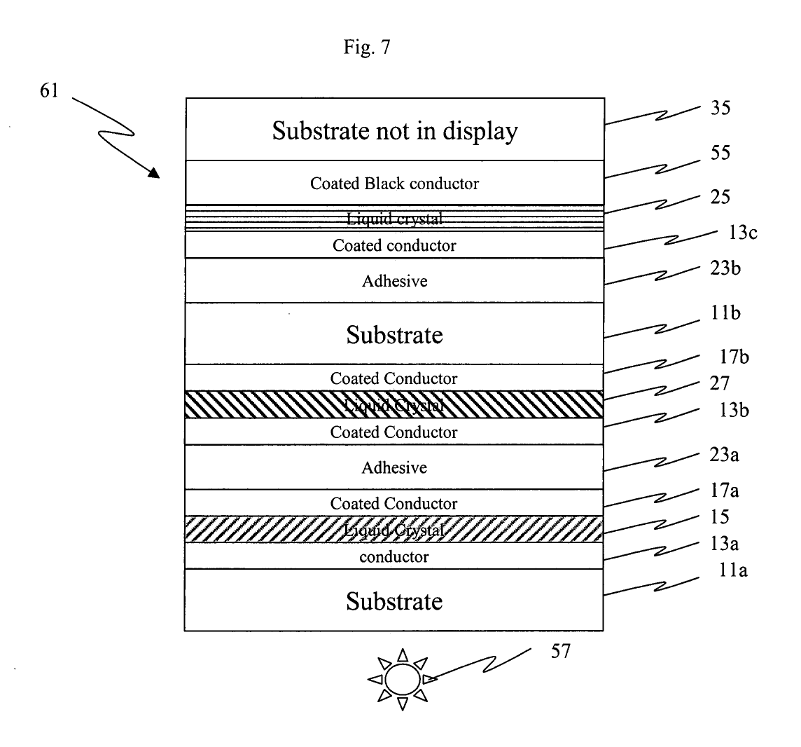

FIG. 7 provides a cross section of another embodiment of this invention in which the minimum number of layers in the active optical part of the display has only thirteen layers, further reducing the number of layers required. Such a display comprises a transparent substrate 11a with a bottom etched conductor 13a on which a first liquid crystal layer 15 is applied. A top conductor 17a is applied on top of layer 15. A layer of adhesive 23a is used to adhere a second liquid crystal assembled display cell that is made up of a bottom conductor 13b, a liquid crystal second layer 27 and a top conductor 17b and a transparent substrate 11b. Another layer of adhesive 23b is used to adhere a third assembled display cell of liquid crystal that has a bottom conductor 13c, a third liquid crystal layer 25 and an etched black conductor 55 and substrate 35 that is not in the active view plane of the display. The inactive part of the display or the part of the display not in the active viewing plane of the display is defined as any layer that is attached to the display but through which no substantial amount of light passes. Conversely, the active part of the display is the any portion through which light passes to provide a viewable part of the functional image.

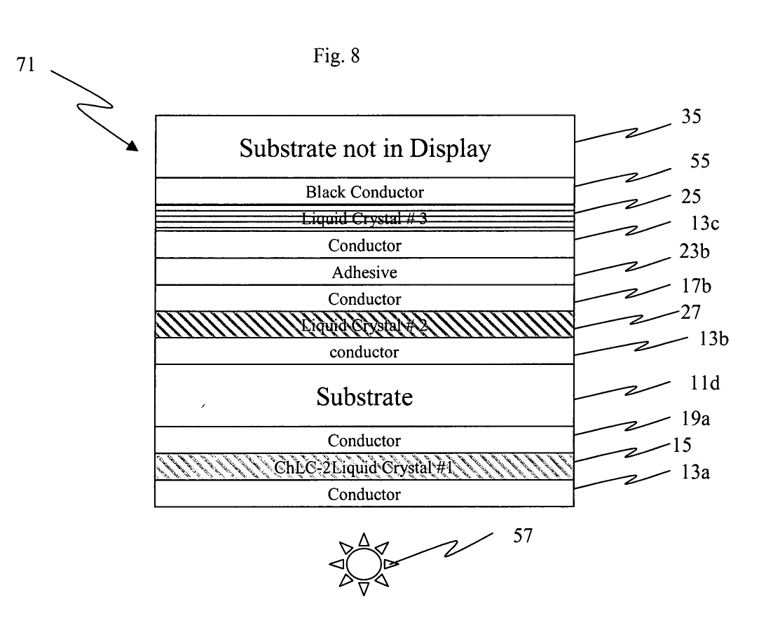

FIG. 8 is a cross section of one embodiment of this invention in which three color display has eleven layers as a minimum number required to make this display function. Such a display only has one substrate in the active optical viewing portion of the display. Such a display has in order from the viewing side, a bottom conductor 13a, a first liquid crystal layer 15 and top conductor 19a and transparent substrate 11a on which has been previously disposed a bottom conductor 13b, a second liquid crystal layer 27 and a top conductor 17b. Such a configuration may be built as a single unit and then adhered to a second single assembled display cell with an adhesive layer 23a. The second single assembled display cell display comprises in order from the viewing side, a bottom conductor 13c, a third liquid crystal layer 25, a black etched conductor 55 and a substrate 35 that is not in the active view plane of the display. Since layer 13a is a bottom conductor on the view side and may be prone to damage, it may be desirable to provide an additional protective layer (not shown in the figure).

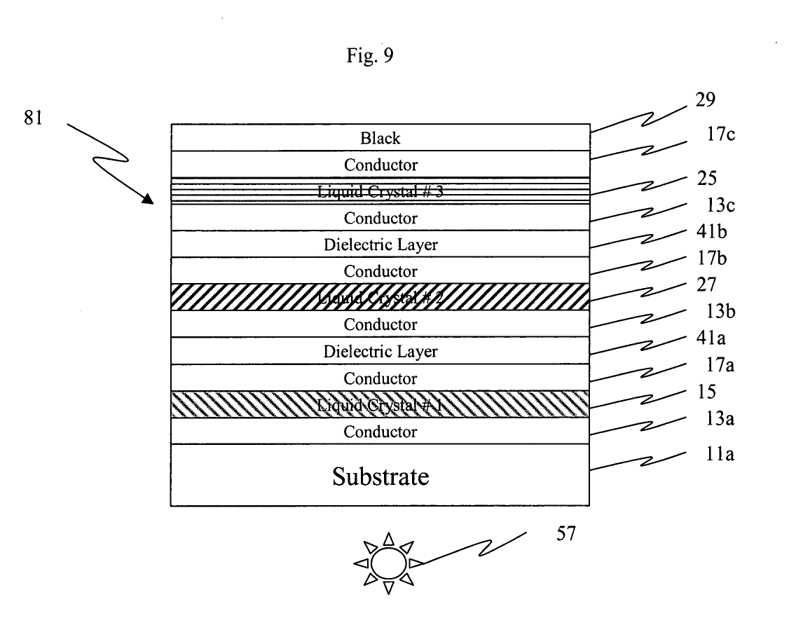

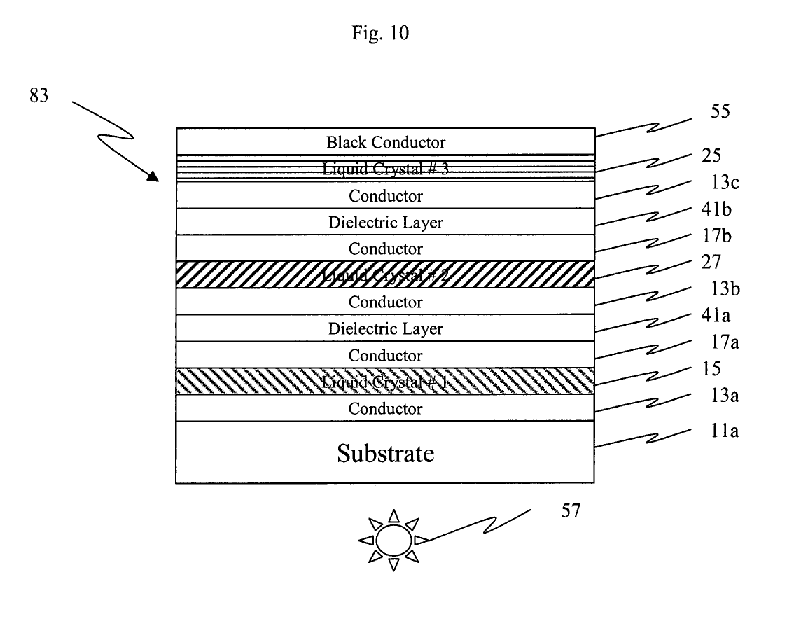

FIG. 9 is a cross section of a three-color display that has thirteen layers and only one substrate. Such a display may be built completely by coating. Such a display may comprise from the viewing side, a transparent substrate 11a with a bottom conductor 13a with a first liquid crystal layer 17 and a top conductor 17a and then a dielectric insulating layer 41a with a bottom electrode 13b and a second liquid crystal layer 27 and a top conductor layer 17b and a coated dielectric insulating layer 41b. Another bottom layer conductor 13c is then applied to layer 41b and then a third liquid crystal layer 25 followed by a top conductor 17c and black absorbing layer 29. FIG. 9 can be made with one less layer if the black absorber layer 29 and the adjacent top conductor 17c are replaced with an etched black conductor 55. This is shown in FIG. 10.

FIG. 10 is another embodiment of this invention. It has twelve layers and uses only one substrate. Such a display may be built completely by coating. Such a display may comprise from the viewing side, a transparent substrate 11a with a bottom conductor 13a with a first liquid crystal layer 17 and a top conductor 17a and then a dielectric insulating layer 41a with a bottom electrode 13b and a second liquid crystal layer 27 and a top conductor layer 17b and a coated dielectric insulating layer 41b. Another bottom layer conductor 13c is then applied to layer 41b and then a third liquid crystal layer 25 followed by a top conductor 17c and etched black conductor 55.

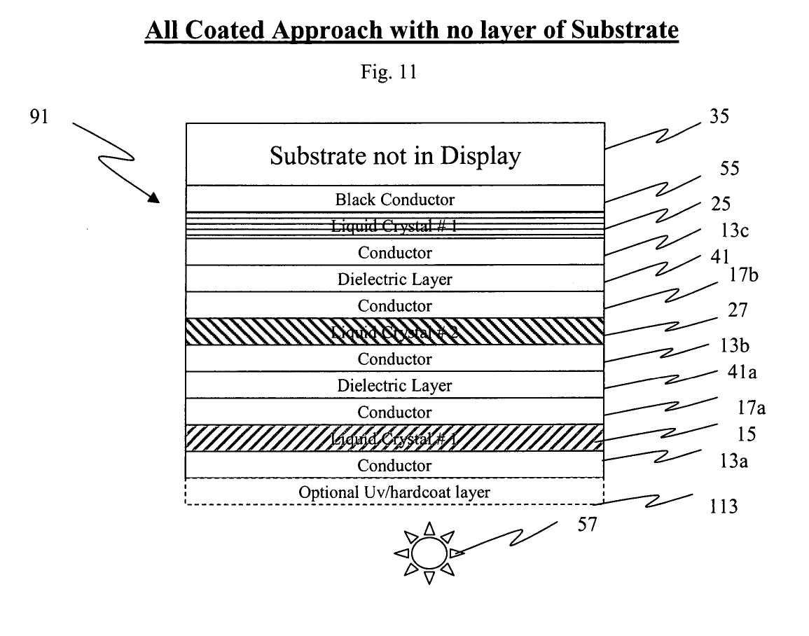

FIG. 11 is another embodiment of this invention in which no substrate is required in the active optical portion of the display. Such a display may contain an optional substrate that aids in the coating of the various layers. FIG. 11 is similar in design as FIG. 10, except this display is made by coating and printing the layers as opposed to making separate assembled display cells and then adhering them together. Such a display, in order from the viewing side (opposite from the order that they are actually coated or printed in), comprises a bottom conductor 13a, a first liquid crystal layer 15, a top conductor 17a, a coated dielectric insulating layer 41a, a second bottom conductor 13b, a second liquid crystal layer 27, a top conductor 17b, a second dielectric insulating layer 41b, a third bottom conductor 13c, a third liquid crystal layer 25, a black conductor 55 and a substrate 35 that is not in the active view plane of the display. Since the bottom layer on the view side is a conductive electrode it may be desirable to provide an optional layer 113 that provides a hard coat layer for scratch protection as well as a UV absorbing layer to protect the liquid crystal layers from fading.

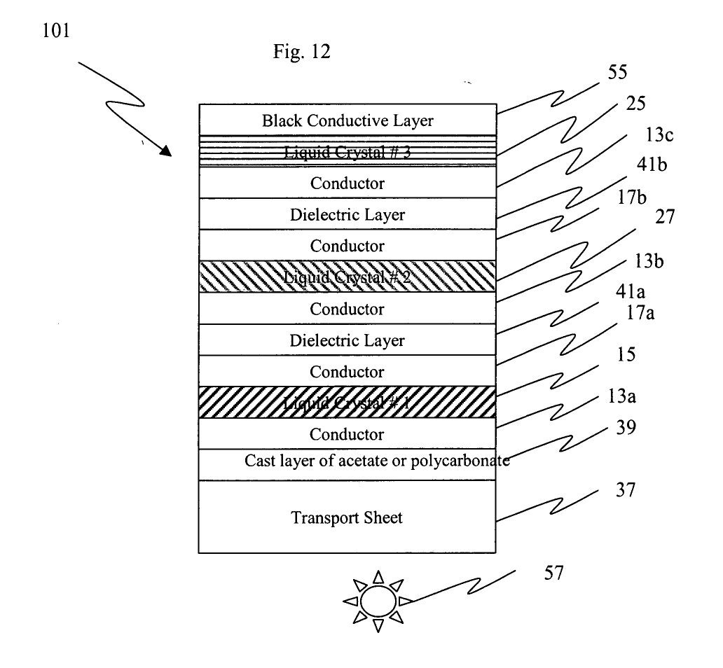

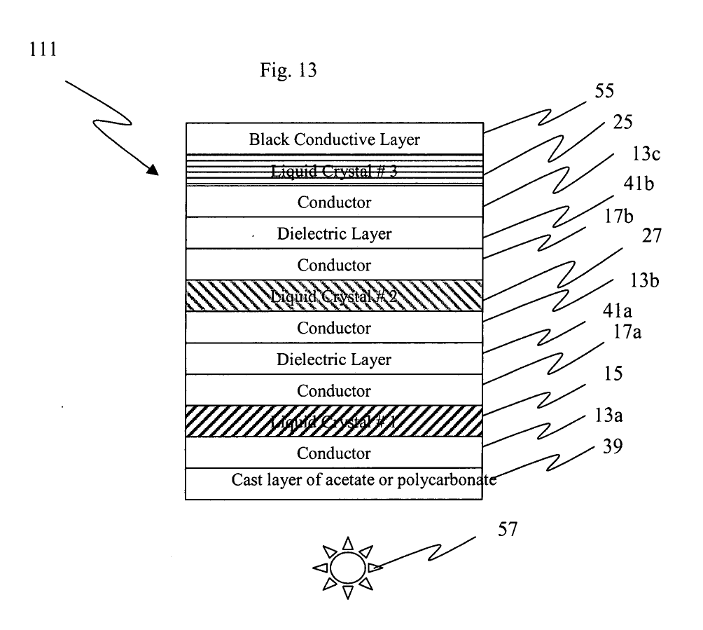

FIGS. 12 and 13 illustrate one embodiment of this invention in which a three-color display is built on a transport sheet and then removed from the transport sheet. Such a display can be made very thin and is very flexible. FIG. 12 is a display comprising in order from the view side a transport sheet 37, a layer of clear polymer 39 that has relative poor adhesion to the transport sheet and serves as the separation interface between the transport sheet and the useable display, a bottom conductor 13a, a first liquid crystal layer 17, a top conductor 19a, a dielectric insulating layer 41a, a bottom conductor 13b, a second liquid crystal layer 27, a top conductor 19b, a dielectric insulating layer 41b, a bottom conductor 13c, a third liquid crystal layer 25 and black conductive layer 55. In FIG. 13, transport sheet 37 is removed. It should be noted that 12 may be a display if the transport sheet is transparent.

In a preferred embodiment the first liquid crystal layer is blue, the second layer of liquid is green and the third layer of liquid is red. Such an embodiment is preferred because there is less color overlap when the layers are in this order and therefore provides improved optical performance. In another embodiment of this invention the first liquid is green, the second liquid crystal layer is blue and the third liquid crystal layer is red. In another embodiment the red, green and blue liquid crystal layers may be in any order. It has also been found that when stacking two colored liquid crystal layers, specifically, blue and yellow liquid crystal, that the resulting color appears to be white.

As used herein, a “liquid crystal display” (LCD) is a type of flat panel display used in various electronic devices. At a minimum, an LCD comprises a substrate, at least one conductive layer and a liquid crystal layer. LCDs may also comprise two sheets of polarizing material with a liquid crystal solution between the polarizing sheets. The sheets of polarizing material may comprise a substrate of glass or transparent plastic. The LCD may also include functional layers. In one embodiment of an LCD, a transparent, multilayer flexible support is coated with a first conductive layer, which may be patterned, onto which is coated the light modulating liquid crystal layer. A second conductive layer is applied and overcoated with a dielectric insulating layer to which dielectric conductive row contacts are attached, including vias that permit interconnection between conductive layers and the dielectric conductive row contacts. An optional nanopigmented functional layer may be applied between the liquid crystal layer and the second conductive layer. In a typical matrix addressable light emitting display device, numerous light emitting devices are formed on a single substrate and arranged in groups in a regular grid pattern. Activation may be by rows and columns.

The liquid crystal (LC) is used as an optical switch. The substrates are usually manufactured with transparent, conductive electrodes, in which electrical “driving” signals are coupled. The driving signals induce an electric field which can cause a phase change or state change in the LC material, the LC exhibiting different light reflecting characteristics according to its phase and/or state.

Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral nematic liquid crystal refers to the type of liquid crystal having finer pitch than that of twisted nematic and super-twisted nematic used in commonly encountered LC devices. Chiral nematic liquid crystals are so named because such liquid crystal formulations are commonly obtained by adding chiral agents to host nematic liquid crystals. Chiral nematic liquid crystals may be used to produce bistable or multi-stable displays. These devices have significantly reduced power consumption due to their nonvolatile “memory” characteristic. Since such displays do not require a continuous driving circuit to maintain an image, they consume significantly reduced power. Chiral nematic displays are bistable in the absence of a field; the two stable states are the reflective planar state and the weakly scattering focal conic state. In the planar state, the helical axes of the chiral nematic liquid crystal molecules are substantially perpendicular to the substrate upon which the liquid crystal is disposed. In the focal conic state the helical axes of the liquid crystal molecules are generally randomly oriented. Adjusting the concentration of chiral dopants in the chiral nematic material modulates the pitch length of the mesophase and, thus, the wavelength of radiation reflected. Chiral nematic materials that reflect infrared radiation and ultraviolet have been used for purposes of scientific study. Commercial displays are most often fabricated from chiral nematic materials that reflect visible light. Some known LCD devices include chemically etched, transparent, conductive layers overlying a glass substrate as described in U.S. Pat. No. 5,667,853, incorporated herein by reference.

In one embodiment, a chiral nematic liquid crystal composition may be dispersed in a continuous matrix. Such materials are referred to as “polymer dispersed liquid crystal” materials or “PDLC” materials. Such materials can be made by a variety of methods. For example, Doane et al. (Applied Physics Letters, 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a domain and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid crystal material and polymer (a hydroxy functionalized polymethylmethacrylate) along with a crosslinker for the polymer are dissolved in a common organic solvent toluene and coated on an indium tin oxide (ITO) substrate. A dispersion of the liquid crystal material in the polymer binder is formed upon evaporation of toluene at high temperature. The phase separation methods of Doane et al. and West et al. require the use of organic solvents that may be objectionable in certain manufacturing environments.

The liquid crystalline droplets or domains are typically dispersed in a continuous binder. Suitable hydrophilic binders include both naturally occurring substances such as proteins, protein derivatives, cellulose derivatives (for example cellulose esters), gelatins and gelatin derivatives, polysaccaharides, casein, and the like, and synthetic water permeable colloids such as poly(vinyl lactams), acrylamide polymers, latex, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl acrylate and methacrylates, vinyl imidazole copolymers, vinyl sulfide copolymers, and homopolymer or copolymers containing styrene sulfonic acid. Gelatin is preferred.

Useful “gelatins,” as that term is used generically herein, include alkali treated gelatin (cattle bone or hide gelatin), acid treated gelatin (pigskin gelatin) and gelatin derivatives such as acetylated gelatin, phthalated gelatin and the like. Other hydrophilic colloids that can be utilized alone or in combination with gelatin include dextran, gum arabic, zein, casein, pectin, collagen derivatives, collodion, agar-agar, arrowroot, albumin, and the like. Still other useful hydrophilic colloids are water soluble polyvinyl compounds such as polyvinyl alcohol, polyacrylamide, poly(vinylpyrrolidone), and the like. Useful liquid crystal to gelatin ratios should be between 6:1 and 0.5:1 liquid crystal to gelatin, preferably 8:5.

Other organic binders such as polyvinyl alcohol (PVA) or polyethylene oxide (PEO) can be used as minor components of the binder in addition to gelatin. Such compounds are preferably machine coatable on equipment associated with photographic films.

It is desirable that the binder has a low ionic content. The presence of ions in such a binder hinders the development of an electrical field across the dispersed liquid crystal material. Additionally, ions in the binder can migrate in the presence of an electrical field, chemically damaging the light modulating layer. The coating thickness, size of the liquid crystal domains, and concentration of the domains of liquid crystal materials are designed for optimum optical properties. Heretofore, the dispersion of liquid crystals is performed using shear mills or other mechanical separating means to form domains of liquid crystal within the light modulating layer.

A conventional surfactant can be added to the emulsion to improve coating of the layer. Surfactants can be of conventional design, and are provided at a concentration that corresponds to the critical micelle concentration (CMC) of the solution. A preferred surfactant is a mixture of the sodium salts of diisopropyl and triisopropyl naphthalene sulfonate, commercially available from DuPont, Inc. (Wilmington, Del.) as ALKANOL XC surfactant. In order to prevent the hydrophilic colloid from removing the suspension stabilizing agent from the surface of the lubricant droplets, suitable anionic surfactants may be included in the mixing step to prepare the coating composition such as polyisopropyl naphthalene-sodium sulfonate, sodium dodecyl sulfate, sodium dodecyl benzene sulfonate, as well as those anionic surfactants set forth in U.S. Pat. No. 5,326,687 and in Section XI of Research Disclosure 308119, December 1989, entitled “Photographic Silver Halide Emulsions, Preparations, Addenda, Processing, and Systems”, both of which are incorporated herein by reference. Aromatic sulfonates are more preferred and polyisopropyl naphthalene sulfonate is most preferred.

In one embodiment, a chiral nematic liquid crystal composition may be dispersed in a continuous polymeric matrix. Such materials are referred to as “polymer dispersed liquid crystal” materials or “PDLC” materials. Such materials can be made by a variety of methods. For example, Doane et al. (Applied Physics Letters, 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a droplet or domain and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid crystal material and polymer (a hydroxy functionalized polymethylmethacrylate) along with a crosslinker for the polymer are dissolved in a common organic solvent toluene and coated on an indium tin oxide (ITO) substrate. A dispersion of the liquid crystal material in the polymer binder is formed upon evaporation of toluene at high temperature. The phase separation methods of Doane et al. and West et al. require the use of organic solvents that may be objectionable in certain manufacturing environments.

The liquid crystal and gelatin emulsion are coated and dried to a thickness of between 5 and 30 microns to optimize optical properties of light modulating layer. In one embodiment, the layer is coated to provide a final coating containing a substantial monolayer of N*LC domains. The term “substantial monolayer” is defined by the Applicants to mean that, in a direction perpendicular to the plane of the display, there is no more than a single layer of domains sandwiched between the electrodes at most points of the display (or the imaging layer).

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

The liquid crystal material in binder may be dueled with an aqueous hardener solution to create a material resistant to humidity and temperature variations when used the display. The addition of a bacteriostat prevents gelatin degradation during emulsion storage and during material operation. The gelatin concentration in the emulsion when coated is preferably between about 2 and 20 weight percent based on the weight of the emulsion. In the final emulsion, the liquid crystal material may be dispersed at 8% concentration in a 5% gelatin aqueous solution.

Although hardened gelatin is used in photographs to harden the material, the need is not the same in liquid crystal displays in which the gelatin is typically protected by several layers of material including a plastic or glass substrate. Typically, liquid crystal material is wicked between plates of glass. Furthermore, unless necessary, a gelatin hardener can be problematic for coating a gelatin material and may require more difficult manufacture. However, gelatin, containing hardener, may optionally be used in the present invention. In the context of this invention, hardeners are defined as any additive, which causes chemical crosslinking in gelatin or gelatin derivatives.

Many conventional hardeners are known to crosslink gelatin. Gelatin crosslinking agents (i.e., the hardener) are included in an amount of at least about 0.01 wt. % and preferably from about 0.1 to about 10 wt. % based on the weight of the solid dried gelatin material used (by dried gelatin it is meant substantially dry gelatin at ambient conditions as for example obtained from Eastman Gel Co., as compared to swollen gelatin), and more preferably in the amount of from about 1 to about 5 percent by weight. More than one gelatin crosslinking agent can be used if desired. Suitable hardeners may include inorganic, organic hardeners, such as aldehyde hardeners and olefinic hardeners. Inorganic hardeners include compounds such as aluminum salts, especially the sulfate, potassium and ammonium alums, ammonium zirconium carbonate, chromium salts such as chromium sulfate and chromium alum, and salts of titanium dioxide, and zirconium dioxide. Representative organic hardeners or gelatin crosslinking agents may include aldehyde and related compounds, pyridiniums, olefins, carbodiimides, and epoxides. Thus, suitable aldehyde hardeners include formaldehyde and compounds that contain two or more aldehyde functional groups such as glyoxal, gluteraldehyde and the like. Other preferred hardeners include compounds that contain blocked aldehyde functional groups such as aldehydes of the type tetrahydro-4-hydroxy-5-methyl-2(1H)-pyrimidinone polymers (Sequa SUNREZ® 700), polymers of the type having a glyoxal polyol reaction product consisting of 1 anhydroglucose unit: 2 glyoxal units (SEQUAREZ® 755 obtained from Sequa Chemicals, Inc.), DME-Melamine non-formaldehyde resins such as Sequa CPD3046-76 obtained from Sequa Chemicals Inc., and 2,3-dihydroxy-1,4-dioxane (DHD). Thus, hardeners that contain active olefinic functional groups include, for example, bis-(vinylsulfonyl)-methane (BVSM), bis-(vinylsulfonyl-methyl) ether (BVSME), 1,3,5-triacryloylhexahydro-s-triazine, and the like. In the context of the present invention, active olefinic compounds are defined as compounds having two or more olefinic bonds, especially unsubstituted vinyl groups, activated by adjacent electron withdrawing groups (The Theory of the Photographic Process, 4th Edition, T. H. James, 1977, Macmillan Publishing Co., page 82). Other examples of hardening agents can be found in standard references such as The Theory of the Photographic Process, T. H. James, Macmillan Publishing Co., Inc. (New York 1977) or in Research Disclosure, September 1996, Vol. 389, Part IIB (Hardeners) or in Research Disclosure, September 1994, Vol. 365, Item 36544, Part IIB (Hardeners). Research Disclosure is published by Kenneth Mason Publications, Ltd., Dudley House, 12 North St., Emsworth, Hampshire P010 7DQ, England. Olefinic hardeners are most preferred, as disclosed in U.S. Pat. Nos. 3,689,274, 2,994,611, 3,642,486, 3,490,911, 3,635,718, 3,640,720, 2,992,109, 3,232,763, and 3,360,372.

Among hardeners of the active olefin type, a particularly preferred class of hardeners is compounds comprising two or more vinyl sulfonyl groups. These compounds are hereinafter referred to as “vinyl sulfones”. Compounds of this type are described in numerous patents including, for example, U.S. Pat. Nos. 3,490,911, 3,642,486, 3,841,872 and 4,171,976. Vinyl sulfone hardeners are believed to be effective as hardeners as a result of their ability to crosslink polymers making up the colloid.

The liquid crystalline droplets or domains may be formed by any method, known to those of skill in the art, which will allow control of the domain size. In a preferred embodiment, a method referred to as “limited coalescence” is used to form uniformly sized emulsions of liquid crystalline material. For example, the liquid crystal material can be homogenized in the presence of finely divided silica, a coalescence limiting material, such as LUDOX® from DuPont Corporation. A promoter material can be added to the aqueous bath to drive the colloidal particles to the liquid-liquid interface. In a preferred embodiment, a copolymer of adipic acid and 2-(methylamino)ethanol can be used as the promoting agent in the water bath. The liquid crystal material can be dispersed using ultrasound to create liquid crystal domains below 1 micron in size. When the ultrasound energy is removed, the liquid crystal material coalesces into domains of uniform size. For domains to be of uniform size, the ratio of smallest to largest domain size for one emulsion varies by approximately 1:2. By varying the amount of silica and copolymer relative to the liquid crystalline material, uniform domain size emulsions of the desired average diameter (by microscopy), for example 3 or 8 micron, can be produced. These emulsions can be diluted into gelatin solution for subsequent coating. To achieve improved brightness and reduced roughness two or more emulsions are blended to form one coating. The various emulsions can be blended at several different times in the coating process. The limited coalescent materials can be coated using a photographic emulsion coating machine onto sheets of polyester having an ITO coating with a sheet conductivity of 300 ohms per square. The coating can be dried to provide a polymerically dispersed cholesteric coating. By using limited coalescence, there are few, if any, parasitic smaller domains (having undesirable electro-optical properties) within the dried coatings.

In addition to binder and hardener, liquid crystal layers may also contain a small amount of light absorbing colorant, preferably an absorber dye. It is preferred that an absorbing dye is used to selectively absorb back scattered light from the focal conic state at the lowest wavelengths in the visible part of the spectrum. Further, the colorant selectively absorbs similarly scattered light from the planar state, while only minimally absorbing the main body of reflected light. The colorants may include both dyes and pigments. The colorant may absorb light components, which may cause turbidity of color in the color display performed by selective reflection of the liquid crystal or may cause lowering of a transparency in the transparent state of the liquid crystal, and therefore can improve the display quality. Two or more of the components in the liquid crystal display may contain a coloring agent. For example, both the polymer and the liquid crystal may contain the coloring agent. Preferably, a colorant is selected, which absorbs rays in a range of shorter wavelengths than the selective reflection wavelength of the liquid crystal.

Any amount of colorant may be used, provided that addition of the colorant does not remarkably impair the switching characteristics of the liquid crystal material for display. In addition, if the polymeric binder is formed by polymerization, the addition does not inhibit the polymerization. An exemplary amount of colorant is from at least 0.1 weight % to 5 weight % of the liquid crystal material.

In a preferred embodiment, the colorants, preferably absorber dyes, are incorporated directly in the CLC materials. Any colorants that are miscible with the cholesteric liquid crystal materials are useful for this purpose. Most preferred are colorants that are readily soluble in toluene. By readily soluble is meant preferably a solubility greater than 1 gram per liter, more preferably greater than 10 grams per liter and most preferably greater than 100 grams per liter. The inventors have determined that toluene soluble dyes are most compatible with the cholesteric liquid crystal materials. Suitable colorants are anthraquinone dyes such as Sandoplast Blue 2B from Clariant Corporation, phthalocyanine dyes such as Savinyl Blue GLS from Clariant Corporation or Neozapon Blue 807 from BASF Corporation, methine dyes such as Sandoplast Yellow 3G from Clariant Corporation or metal complex dyes such as Neozapon Yellow 157, Neozapon Orange 251, Neozapon Green 975, Neozapon Blue 807 or Neozapon Red 365 from BASF Corporation. Other colorants are Neopen Blue 808, Neopen Yellow 075, Sudan Orange 220 or Sudan Blue 670 from BASF Corporation. Other types of colorants may include various kinds of dyestuff such as dyestuff for resin coloring and dichromatic dyestuff for liquid crystal display. The dyestuff for resin coloring may be SPR REDI (manufactured by Mitsui Toatsu Senryo Co., Ltd.). The dichromatic dyestuff for liquid crystal is specifically SI-424 or M-483 (both manufactured by Mitsui Toatsu Senryo Co., Ltd.).

The contrast of the display is degraded if there is more than a substantial monolayer of N*LC domains. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

In a preferred embodiment of the invention, the display device or display sheet has simply a single imaging layer of liquid crystal material along a line perpendicular to the face of the display, preferably a single layer coated on a flexible substrate. Such a structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the droplet or domain (or imaging layer) thickness for a majority of the domains. Such a dimensional relationship is shown in U.S. Pat. No. 6,061,107, hereby incorporated by reference in its entirety.

Modern chiral nematic liquid crystal materials usually include at least one nematic host combined with a chiral dopant. In general, the nematic liquid crystal phase is composed of one or more mesogenic components combined to provide useful composite properties. The nematic component of the chiral nematic liquid crystal mixture may be comprised of any suitable nematic liquid crystal mixture or composition having appropriate liquid crystal characteristics. Nematic liquid crystals suitable for use in the present invention are preferably composed of compounds of low molecular weight selected from nematic or nematogenic substances, for example from the known classes of the azoxybenzenes, benzylideneanilines, biphenyls, terphenyls, phenyl or cyclohexyl benzoates, phenyl or cyclohexyl esters of cyclohexanecarboxylic acid; phenyl or cyclohexyl esters of cyclohexylbenzoic acid; phenyl or cyclohexyl esters of cyclohexylcyclohexanecarboxylic acid; cyclohexylphenyl esters of benzoic acid, of cyclohexanecarboxyiic acid and of cyclohexylcyclohexanecarboxylic acid; phenyl cyclohexanes; cyclohexylbiphenyls; phenyl cyclohexylcyclohexanes; cyclohexylcyclohexanes; cyclohexylcyclohexenes; cyclohexylcyclohexylcyclohexenes; 1,4-bis-cyclohexylbenzenes; 4,4-bis-cyclohexylbiphenyls; phenyl- or cyclohexylpyrimidines; phenyl- or cyclohexylpyridines; phenyl- or cyclohexylpyridazines; phenyl- or cyclohexyldioxanes; phenyl- or cyclohexyl-1,3-dithianes; 1,2-diphenylethanes; 1,2-dicyclohexylethanes; 1-phenyl-2-cyclohexylethanes; 1-cyclohexyl-2-(4-phenylcyclohexyl)ethanes; 1-cyclohexyl-2′,2-biphenylethanes; 1-phenyl-2-cyclohexylphenylethanes; optionally halogenated stilbenes; benzyl phenyl ethers; tolanes; substituted cinnamic acids and esters; and further classes of nematic or nematogenic substances. The 1,4-phenylene groups in these compounds may also be laterally mono- or difluorinated. The liquid crystalline material of this preferred embodiment is based on the achiral compounds of this type. The most important compounds, that are possible as components of these liquid crystalline materials, can be characterized by the following formula R′—X—Y-Z-R″ wherein X and Z, which may be identical or different, are in each case, independently from one another, a bivalent radical from the group formed by -Phe-, -Cyc-, -Phe-Phe-, -Phe-Cyc-, -Cyc-Cyc-, -Pyr-, -Dio-, —B-Phe- and —B-Cyc-; wherein Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl, and B is 2-(trans-1,4-cyclohexyl)ethyl, pyrimidine-2,5-diyl, pyridine-2,5-diyl or 1,3-dioxane-2,5-diyl. Y in these compounds is selected from the following bivalent groups —CH═CH—, —C≡C—, —N═N(O)—, —CH═CY′—, —CH═N(O)—, —CH2—CH2—, —CO—O—, —CH2—O—, —CO—S—, —CH2—S—, —COO-Phe-COO— or a single bond, with Y′ being halogen, preferably chlorine, or —CN; R′ and R″ are, in each case, independently of one another, alkyl, alkenyl, alkoxy, alkenyloxy, alkanoyloxy, alkoxycarbonyl or alkoxycarbonyloxy with 1 to 18, preferably 1 to 12 C atoms, or alternatively one of R′ and R″ is —F, —CF3, —OCF3, —Cl, —NCS or —CN. In most of these compounds R′ and R′ are, in each case, independently of each another, alkyl, alkenyl or alkoxy with different chain length, wherein the sum of C atoms in nematic media generally is between 2 and 9, preferably between 2 and 7. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral nematic liquid crystal compositions preferably have a positive dielectric anisotropy and include chiral material in an amount effective to form focal conic and twisted planar states. Chiral nematic liquid crystal materials are preferred because of their excellent reflective characteristics, bistability and gray scale memory. The chiral nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: for example, G. Gottarelli and G. Spada, Mol. Cryst. Liq. Crys., 123, 377 (1985); G. Spada and G. Proni, Enantiomer, 3, 301 (1998) and references therein. Typical well known dopant classes include 1,1-binaphthol derivatives; isosorbide and similar isomannide esters as disclosed in U.S. Pat. No. 6,217,792; TADDOL derivatives, as disclosed in U.S. Pat. No. 6,099,751; and the pending spiroindanes esters, as disclosed in U.S. patent application Ser. No. 10/651,692 by T. Welter et al., filed Aug. 29, 2003, titled “Chiral Compounds And Compositions Containing The Same,” hereby incorporated by reference.

The pitch length of the liquid crystal materials may be adjusted based upon the following equation (1):
λₘₐₓ=nₐᵥp₀
where λₘₐₓ is the peak reflection wavelength, that is, the wavelength at which reflectance is a maximum, nₐᵥ is the average index of refraction of the liquid crystal material, and p₀ is the natural pitch length of the chiral nematic helix. Definitions of chiral nematic helix and pitch length and methods of its measurement, are known to those skilled in the art such as can be found in the book, Blinov, L. M., Electro-optical and Magneto-Optical Properties of Liquid Crystals, John Wiley & Sons Ltd. 1983. The pitch length is modified by adjusting the concentration of the chiral material in the liquid crystal material. For most concentrations of chiral dopants, the pitch length induced by the dopant is inversely proportional to the concentration of the dopant. The proportionality constant is given by the following equation (2):
p₀=1/(HTP.c)
where c is the concentration of the chiral dopant and HTP is the proportionality constant.

For some applications, it is desired to have LC mixtures that exhibit a strong helical twist and thereby a short pitch length. For example in liquid crystalline mixtures that are used in selectively reflecting chiral nematic displays, the pitch has to be selected such that the maximum of the wavelength reflected by the chiral nematic helix is in the range of visible light. Other possible applications are polymer films with a chiral liquid crystalline phase for optical elements, such as chiral nematic broadband polarizers, filter arrays, or chiral liquid crystalline retardation films. Among these are active and passive optical elements or color filters and liquid crystal displays, for example STN, TN, AMD-TN, temperature compensation, polymer free or polymer stabilized chiral nematic (PFCT, PSCT) displays. Possible display industry applications include ultralight, flexible, and inexpensive displays for notebook and desktop computers, instrument panels, video game machines, videophones, mobile phones, hand held PCs, PDAs, e-books, camcorders, satellite navigation systems, store and supermarket pricing systems, highway signs, informational displays, smart cards, toys, and other electronic devices.

Although the preferred embodiment utilizes an electrically modulated imaging layer of liquid crystal for the imageable layer, other electrically modulated materials may be used. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as Gyricon particles, or electrochromic.

In a preferred embodiment, the other electrically imageable material can also be addressed with an electric field and then retain its image after the electric field is removed, a property typically referred to as “bistable”. Particularly suitable electrically imageable materials that exhibit “bistability” are electrochemical, electrophoretic, such as Gyricon particles, electrochromic, or magnetic.

The electrically modulated material may also be a printable, conductive ink having an arrangement of particles or microscopic containers or microcapsules. Each microcapsule contains an electrophoretic composition of a fluid, such as a dielectric or emulsion fluid, and a suspension of colored or charged particles or colloidal material. The diameter of the microcapsules typically ranges from about 30 to about 300 microns. According to one practice, the particles visually contrast with the dielectric fluid. According to another example, the electrically modulated material may include rotatable balls that can rotate to expose a different colored surface area, and which can migrate between a forward viewing position and/or a rear nonviewing position, such as gyricon. Specifically, gyricon is a material comprised of twisting rotating elements contained in liquid filled spherical cavities and embedded in an elastomer medium. The rotating elements may be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of about 100 microns. Gyricon materials are disclosed in U.S. Pat. No. 6,147,791, U.S. Pat. No. 4,126,854 and U.S. Pat. No. 6,055,091, the contents of which are herein incorporated by reference.

According to one practice, the microcapsules may be filled with electrically charged white particles in a black or colored dye. Examples of electrically modulated material and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated material may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material. According to a preferred embodiment, the particle diameters of the microcapsules are between about 5 microns and about 200 microns, and the particle diameters of the charged particles are between about one-thousandth and one-fifth the size of the particle diameters of the microcapsules.

Further, the electrically modulated material may include a thermochromic material. A thermochromic material is capable of changing its state alternately between transparent and opaque upon the application of heat. In this manner, a thermochromic imaging material develops images through the application of heat at specific pixel locations in order to form an image. The thermochromic imaging material retains a particular image until heat is again applied to the material. Since the rewritable material is transparent, UV fluorescent printings, designs and patterns underneath can be seen through.

The electrically modulated material may also include surface stabilized ferroelectric liquid crystals (SSFLC). Surface stabilized ferroelectric liquid crystals confining ferroelectric liquid crystal material between closely spaced glass plates to suppress the natural helix configuration of the crystals. The domains switch rapidly between two optically distinct, stable states simply by alternating the sign of an applied electric field.

Magnetic particles suspended in an emulsion comprise an additional imaging material suitable for use with the present invention. Application of a magnetic force alters pixels formed with the magnetic particles in order to create, update or change human and/or machine readable indicia. Those skilled in the art will recognize that a variety of bistable nonvolatile imaging materials are available and may be implemented in the present invention.

An electrochromic material can be defined as a chemical or chemical composition in which a change in transparency at a specified wavelength can be induced via an electrical stimulus, as in the liquid crystal display of many calculators. Electrochromics have shown much promise in areas such as display technologies (in the form of simple signs, billboards, and as cash register displays), as dimming mirrors for automobiles, and as dimming windows for buildings. One advantage that electrochromics would have over conventional liquid crystalline displays is that the level of transparency or opaqueness can be tuned via the amount of current applied. Materials most commonly used and studied for electrochromic use are either inorganic (tungsten trioxide, iridium dioxide) or organic dyes. Conjugated polymers can very much be viewed as organic dyes which have mechanical integrity to be cast in thin films and, over the past decade or so, these materials have been exploited for use in electrochromic devices. A stable low band gap polymer, poly(thieno[3,4-b]thiophene is another useful electrochromic material.

Electrochromism denotes the characteristic color change of a material associated with the material's reduction-oxidation state. Electrochemical switching of electrochromic materials results in different optical absorption spectra. An electrochromic display element consists of at least two conductors, an electrochromic material, and an electrolyte combined on a carrying substrate.

A display made entirely of organic polymers (the electroactive materials) and an organic electrolyte applied or coated on a substrate such as glass, flexible polymer or even paper. Typical display elements are updated by applying a voltage of typically 0.6 to 0.9 V. Switching the color can take about 1 second. The energy required for one switch cycle (1 cm2 display area) is less than 1 mJ.

Electrochromic windows can control the amount of daylight and solar heat gain through the windows of buildings. The ability to control these parameters using an electronic circuit suggests a variety of applications. A small photovoltaic cell could be used to sense the amount of sunlight, darkening the window when the sun is brightest. This would be an appropriate application in a hot climate where solar heating is not desired. The photovoltaic cell could be used to lighten the window when direct sunlight is available, but darken it for privacy at other times. This approach would be useful in areas where solar heating is desired. It is an oxidation reaction in which molecules in a compound lose an electron. Ions in the sandwiched electrochromic layer are what allow the material to change from opaque to transparent. A power source is wired to the two conducting oxide layers, and a voltage drives the ions from an ion storage layer, through the ion conducting layer and into the electrochromic layer. This makes a window or display change from transparent to opaque. When power is turned off, the process reverses itself. A full-color display could be made by stacking different color layers.

The electrically modulated material may also be configured as a single color, such as black, white or clear, and may be fluorescent, iridescent, bioluminescent, incandescent, ultraviolet, infrared, or may include a wavelength specific radiation absorbing or emitting material. There may be multiple layers of electrically modulated material. Different layers or regions of the electrically modulated material display material may have different properties or colors. Moreover, the characteristics of the various layers may be different from each other. For example, one layer can be used to view or display information in the visible light range, while a second layer responds to or emits ultraviolet light. The nonvisible layers may alternatively be constructed of non-electrically modulated material based materials that have the previously listed radiation absorbing or emitting characteristics. The electrically modulated material employed in connection with the present invention preferably has the characteristic that it does not require power to maintain display of indicia. In the most preferred embodiment, when more than one electrically modulated imaging layer is present, the preferred imaging layer is a liquid crystalline material or an electrochromic materials.

The flexible plastic substrate can be any flexible self-supporting plastic film that supports the thin conductive metallic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials. The material used to form the substrate may be opaque or transparent.

The flexible plastic film desirably has sufficient thickness and mechanical integrity so as to be self-supporting, yet should not be so thick as to be rigid. Typically, the flexible plastic substrate is the thickest layer of the composite film in thickness. Consequently, the substrate determines to a large extent the mechanical and thermal stability of the fully structured composite film.

Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 3000-350° C., without damage.

Typically, the flexible plastic substrate is polyethylene terephthalate (PET), polyethylene naphthalate (PEN), polyethersulfone (PES), polycarbonate (PC), polysulfone, a phenolic resin, an epoxy resin, polyester, polyimide, polyamide, polyetherester, polyetheramide, acetate, cellulose acetate, aliphatic polyurethanes, polyacrylonitrile, polytetrafluoroethylenes, polyvinylidene fluorides, poly(methyl(x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. A preferred polyester is an aromatic polyester such as Arylite. Although various examples of plastic substrates are set forth above, it should be appreciated that the substrate can also be formed from other materials such as glass and quartz.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The LCD contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin oxide or indium tin oxide (ITO), or polythiophene. Typically, the conductive layer is sputtered onto the substrate to a resistance of less than 250 ohms per square. Alternatively, conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is the preferred conductive material, as it is a cost effective conductor with good environmental stability, up to 95% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and cholesteric liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The display may also contain a second conductive layer applied to the surface of the light modulating layer. The second conductive layer desirably has sufficient conductivity to carry a field across the light modulating layer. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin oxide or indium tin oxide, resulting in the layer being transparent. Alternatively, second conductive layer may be printed conductive ink.

For higher conductivities, the second conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The second conductive layer may be patterned irradiating the multilayered conductor/substrate structure with ultraviolet radiation so that portions of the conductive layer are ablated therefrom. It is also known to employ an infra red (IR) fiber laser for patterning a metallic conductive layer overlying a plastic film, directly ablating the conductive layer by scanning a pattern over the conductor/film structure. See: Int. Publ. No. WO 99/36261 and “42.2: A New Conductor Structure for Plastic LCD Applications Utilizing ‘All Dry’ Digital Laser Patterning,” 1998 SID International Symposium Digest of Technical Papers, Anaheim, Calif., May 17-22, 1998, no. VOL. 29, May 17, 1998, pages 1099-1101, both incorporated herein by reference.

When making full color displays, it is desirable to build (coat layers) all or part of the display on a substrate and then be able to remove the substrate so it is not part of the final display. In this way, substrates can be made of any material and may be transparent or opaque. The specific substrate may be tailored more for it physical or surface chemistry interactions with the display layers versus its optical properties, because it can be removed. Substrates useful in this invention may include flexible polymer materials such as polyesters, polyolefins, polyamides, and polycarbonates. Additionally, the substrate may include paper or coated paper, glass, acetate or even metallised substrates. The removable substrates may be multilayer and be coated or treated with adhesion modifying layers, such as release layers, for example, silicone, or may further comprise an adhesive layer. A typical adhesive layer preferably has an adhesive strength of less than 250 N/m. The adhesive layer may be formulated to have varying degrees of tackiness and may be separated from the primary transport substrate (web) and re-adhered to a different substrate. In such a case, the different substrate may have some desired properties such as UV absorption that may protect liquid crystal from fading or changing color, IR reflection to prevent the liquid crystal from be affect by heat. Other properties may include antiglare, antireflection, anti-Newton ring layers, quarter wave layers to enhance transmission properties, static control, finger print and other environmentally protective layers.

When used in the present invention, polyvinyl butyral films are created by forming a single layer, or preferably, a multilayer composite on a slide surface of a coating hopper, the multilayer composite including a bottom layer of low viscosity, one or more intermediate layers, and an optional top layer containing a surfactant, flowing the multilayer composite down the slide surface and over a coating lip of the coating hopper, and applying the multilayer composite to a moving substrate. Coating aids and additives may be placed in specific layers to improve film performance or improve manufacturing robustness. For example, a multilayer application allows a surfactant to be placed in the top spreading layer where needed rather than through out the entire wet film. In another example, the molecular weight and concentration of polyvinyl butyral polymer in the lowermost layer may be adjusted to achieve low viscosity and facilitate high speed application of the multilayer composite onto the transport/carrier substrate.

Wrinkling and cockle artifacts may be minimized through the use of the transport substrate. By providing a stiff backing for the polyvinyl butyral film, the transport substrate minimizes dimensional distortion of the polyvinyl butyral resin film. This is particularly advantageous for handling and processing very thin films of less than about 40 microns. In addition, the restraining nature of the transport substrate also eliminates the tendency of polyvinyl butyral films to distort or cockle over time as a result of changes in moisture levels. Thus, the polyvinyl butyral films are dimensionally stable during preparation and storage as well as during final handling steps necessary for fabrication of optical elements.

The polyvinyl butyral film produced for use with the present invention is an optical film. As produced, the polyvinyl butyral film will have a light transmittance of at least about 85 percent, preferably at least about 90 percent, and most preferably, at least about 95 percent. Further, the polyvinyl butyral film will have a haze value of less than 1.0 percent. In addition, the polyvinyl butyrol films are smooth with a surface roughness average of less than 100 nm and most preferrably with a surface roughness of less than 50 nm.

The coating fluids are comprised principally of polyvinyl butyral (PVB) resin dissolved in an organic solvent. Polyvinyl butyrals are a subset of a broader class of polymers known as poly(vinyl acetals). PVB is available in a variety of molecular weights as well as well as degree of vinyl alcohol content. Polyvinyl butyrals are generally formed as a condensation product of polyvinyl alcohol with butyraldehyde in the presence of strong acid. As a result, PVB has substantial hydroxyl functionality from the polyvinyl alcohol segment. The degree of hydroxyl functionality varies among the PVB types and is normally expressed as vinyl alcohol content in weight percent of the polymer. Commercially available PVB is generally produced with either approximately 12% or 19% vinyl alcohol content. The 19% hydroxy functional PVB is normally preferred for the manufacture of laminate films used to prepare safety glass. These PVB laminate films are typically highly plasticized and contain numerous stabilizers or optical brighteners. However, the 19% hydroxy functional PVB is vulnerable to moisture absorption of nominally 0.5% in the pure polymer at 50% relative humidity and as high as 1.0% in the highly plasticized PVB laminates as noted in U.S. Pat. No. 4,952,457 to Cartier. Moisture absorption may contribute to a number of problems in laminate films including poor adhesion. On the other hand, the 12% hydroxy functional PVB exhibits lower moisture absorption of only 0.3% in the pure polymer.

In terms of organic solvents for polyvinyl butyrals, suitable sovlents include, for example, chlorinated solvents (methylene chloride and 1,2 dichloroethane), alcohols (methanol, ethanol, n-propanol, isopropanol, n-butanol, isobutanol, isoamyl alcohol), ketones (acetone, methylethyl ketone, methylisobutyl ketone, and cyclohexanone, diacetone alcohol), esters (methyl acetate, ethyl acetate, n-propyl acetate, isopropyl acetate, isobutyl acetate, and n-butyl acetate), aromatics (toluene and xylenes) and ethers (1,3-dioxolane and tetrahydrofuran). Polyvinyl butyral solutions may be prepared with a blend of the aforementioned solvents. Preferred primary solvents for PVB include methylethhyl ketone, methylene chloride, ethyl acetate, and toluene.

Coating fluids may also contain surfactants as coating aids to control artifacts related to flow after coating. Artifacts created by flow after coating phenomena include mottle, repellencies, orange peel (Bernard cells), and edge withdraw. Surfactants used control flow after coating artifacts include siloxane and fluorochemical compounds. Examples of commercially available surfactants of the siloxane type include: 1.) Polydimethylsiloxanes such as DC200 Fluid from Dow Corning, 2.) Poly(dimethyl, methylphenyl)siloxanes such as DC510 Fluid from Dow Corning, and 3.) Polyalkyl substituted polydimethysiloxanes such as DC190 and DC 1248 from Dow Corning as well as the L7000 Silwet series (L7000, L7001, L7004 and L7230) from Union Carbide, and 4.) Polyalkyl substituted poly(dimethyl, methylphenyl)siloxanes such as SF1023 from General Electric. Examples of commercially available fluorochemical surfactants include: 1) fluorinated alkyl esters such as the Fluorad series (FC430 and FC431) from the 3M Corporation; 2) fluorinated polyoxyethylene ethers such as the Zonyl series (FSN, FSN100, FSO, FSO100) from Du Pont, 3) acrylate:polyperfluoroalkyl ethylacrylates such as the F series (F270 and F600) from NOF Corporation, and 4) perfluoroalkyl derivatives such as the Surflon series (S383, S393, and S8405) from the Asahi Glass Company.

In terms of surfactant distribution, surfactants are most effective when present in the uppermost layers of the multilayer coating. In reference to upper, the term refers to the order in which various layers are coated on a film. Upper refers to the layer on top of, or the layers furthest away from the film. In the uppermost layer, the concentration of surfactant is preferably 0.001-1.000% by weight and most preferably 0.010-0.500%. In addition, lesser amounts of surfactant may be used in the second uppermost layer to minimize diffusion of surfactant away from the uppermost layers. The concentration of surfactant in the second uppermost layer is preferably 0.000-0.200% by weight and most preferably between 0.000-0.100% by weight. Because surfactants are only necessary in the uppermost layers, the overall amount of surfactant remaining in the final dried film is small.

Although surfactants are not required, surfactants do improve the uniformity of the coated film. In particular, mottle nonuniformities are reduced by the use of surfactants. In transparent polyvinyl butyral films, mottle nonuniformities are not readily visualized during casual inspection. To visualize mottle artifacts, organic dyes may be added to the uppermost layer to add color to the coated film. For these dyed films, nonuniformities are easy to see and quantify. In this way, effective surfactant types and levels may be selected for optimum film uniformity.

The first-pass film refers to the formation, typically by coating, of a film layer on a subbed support. This first-pass layer would not include adhesion-improving layers between the film layer and substrate layer, such as a subbing layer. Subsequent coating results in additional layers referred to as second-pass coatings, when a second coating is applied over the first-pass film layer. Additional coating passes may result in multi-layer, multi-pass composite substrates. The practice of multi-pass or tandem coating also has the advantage of minimizing other artifacts such as streak severity, mottle severity, and overall film nonuniformity. The practice of tandem coating or multi-pass coating requires some minimal level of adhesion between the first-pass film and the transport/carrier substrate. In some cases, film/substrate composites having poor adhesion are observed to blister after application of a second or third wet coating in a multi-pass operation. To avoid blister defects, adhesion must be greater than 0.3 N/m between the first-pass film and the transport/carrier substrate. This level of adhesion may be attained by a variety of web treatments including various subbing layers and various electronic discharge treatments. However, excessive adhesion between the applied film and substrate is also undesirable since the film may be damaged during subsequent peeling operations. In particular, film/substrate composites having an adhesive force of greater than 250 N/m have been found to peel poorly. Films peeled from such excessively, well-adhered composites exhibit defects due to tearing of the film and/or due to cohesive failure within the film. In a preferred embodiment of the present invention, the adhesion between the polyvinyl butyral film and the transport/carrier substrate is less than 250 N/m. Most preferably, the adhesion between polycarbonate film and the transport substrate is between 0.5 and 25 N/m.

The polyvinyl butyral resin coatings may be applied to a variety of substrates such as polyethylene terephthalate (PET), polyethylene naphthalate (PEN), polycarbonate, polystyrene, and other polymeric films. Additional substrates may include paper, laminates of paper and polymeric films, glass, cloth, aluminum and other metal supports. In some cases, substrates may be pretreated with subbing layers or electrical discharge devices. Substrates may also be pretreated with functional layers containing various binders and addenda.

Polycarbonate films may also be used in a similar manner to the PVB films described above. The coating fluids are comprised principally of a polycarbonate resin dissolved in an organic solvent. Polymers of the polycarbonate type are available in a variety of molecular weights as well as in numerous permutations around the basic molecular structure. Common to all polycarbonates are the carbonate linkages and usually the presence of stabilizing phenyl groups (Ph) in the polymer backbone. In terms of commercially significant polycarbonates, the condensation product of the dihydridic phenol, 2,2-bis-(4-hydroxyphenyl)-propane (Bisphenol-A), with a carbonate precursor, such as phosogene or diphenyl carbonate, forms a polymer having recurring units of —O-Ph-C(CH.sub.3).sub.2-Ph-O—CO—. Polycarbonates of the Bisphenol-A type are both readily available and relatively inexpensive. Less readily available and more expensive are the numerous polycarbonate copolymers that may be formed by the addition of various dihydric phenol derivatives during polymer synthesis. Examples of such derivatives are 1,1-bis-(4-hydroxyphenyl)cyclohexane (Bisphenol Z), 1,1-bis-(4-hydroxyphenyl)-3,3,5-trimethyl cyclohexane, 2,2-bis-(3-methyl-4-hydroxyphenyl)propane (Bisphenol C), 1,1-bis-(4-hydroxyphenyl)-1-phenyl ethane (Bisphenol P), bis-(4-hydroxyphenyl)-diphenyl methane, among others. These co-polymeric polycarbonates may be formulated to alter material properties such as thermal stability, impact resistance and the like, while maintaining good optical properties. There are no particular restrictions as to the type of polycarbonate or blend of polycarbonate co-polymers used to form a film. Polycarbonate resins are commercially available from General Electric and Bayer.

In terms of organic solvents for polycarbonates, suitable sovlents include, for example, chlorinated solvents (methylene chloride and 1,2 dichloroethane), alcohols (methanol, ethanol, n-propanol, isopropanol, n-butanol, isobutanol, diacetone alcohol, phenol, and cyclohexanol), ketones (acetone, methylethyl ketone, methylisobutyl ketone, and cyclohexanone), esters (methyl acetate, ethyl acetate, n-propyl acetate, isopropyl acetate, isobutyl acetate, and n-butyl acetate), aromatics (toluene and xylenes) and ethers (tetrahydrofuran, 1,3-dioxolane, 1,2-dioxolane, 1,3-dioxane, 1,4-dioxane, and 1,5-dioxane). Polycarbonate solutions may be prepared with a blend of the aforementioned solvents. Preferred primary solvents include methylene chloride and 1,3-dioxolane. Preferred co-solvents include toluene, tetrahydrofuran, cyclohexanone, methanol, ethanol, and isopropanol.

Coating fluids may also contain small amounts of plasticizers. Appropriate plasticizers for polycarbonate films include phthalate esters (diethylphthalate, dibutylphthalate, dicyclohexylphthalate, dioctylphthalate, didecylphthalate and butyl octylphthalate), adipate esters (dioctyl adipate), carbonates (dicetyl carbonate and distearyl carbonate) and phosphate esters (tricresyl phosphate and triphenyl phosphate). Plasticizers are normally used to improve the flow characteristics of polycarbonates processed by the melt extrusion method. However, plasticizers may be used here as coating aids in the converting operation to minimize premature film solidification at the coating hopper and to improve drying characteristics of the wet film. Plasticizers may be used to minimize blistering, curl and delamination of polycarbonate films during the drying operation. Plasticizers may be added to the coating fluid at a total concentration of up to 5% by weight relative to the concentration of polymer in order to mitigate defects in the final polycarbonate film.

Although not required, coating fluids for polycarbonates may also contain surfactants as coating aids to control artifacts related to flow after coating, similar to those previously described for use with PVB, and at similar distributions.

Acetate films may also be utilized in a manner to PVB and polycarbonate films. The coating fluids are comprised principally of a cellulose ester dissolved in an organic solvent. Cellulose esters are commercially available in a variety of molecular weight sizes as well as in the type and degree of alkyl substitution of the hydroxyl groups on the cellulose backbone. Examples of cellulose esters include those having acetyl, proprionyl and butyryl groups. Of particular interest is the family of cellulose esters with acetyl substitution known as cellulose acetate. Of these, the fully acetyl substituted cellulose having a combined acetic acid content of approximately 58.0-62.5% is known as cellulose triacetate (CTA) and is generally preferred for preparing protective covers, compensation films, and substrates used in electronic displays.

In terms of organic solvents for cellulose acetate, suitable sovlents, for example, include chlorinated solvents (methylene chloride and 1,2 dichloroethane), alcohols (methanol, ethanol, n-propanol, isopropanol, n-butanol, isobutanol, diacetone alcohol and cyclohexanol), ketones (acetone, methylethyl ketone, methylisobutyl ketone, and cyclohexanone), esters (methyl acetate, ethyl acetate, n-propyl acetate, isopropyl acetate, isobutyl acetate, n-butyl acetate, and methylacetoacetate), aromatics (toluene and xylenes) and ethers (1,3-dioxolane, 1,2-dioxolane, 1,3-dioxane, 1,4-dioxane, and 1,5-dioxane). In some applications, small amounts of water may be used. Normally, CTA solutions are prepared with a blend of the aforementioned solvents. Preferred primary solvents include methylene chloride, acetone, methyl acetate, and 1,3-dioxolane. Preferred co-solvents include methanol, ethanol, n-butanol and water.

Coating fluids may also contain plasticizers. Appropriate plasticizers for cellulose acetate films include phthalate esters (dimethylphthalate, diethylphthalate, dibutylphthalate, dioctylphthalate, didecylphthalate and butyl octylphthalate), adipate esters (dioctyl adipate), and phosphate esters (tricresyl phosphate and triphenyl phosphate). Plasticizers are normally used to improve the physical and mechanical properties of the final film. In particular, plasticizers are known to improve the flexibility and dimensional stability of cellulose acetate films. However, plasticizers are also used here as coating aids in the converting operation to minimize premature film solidification at the coating hopper and to improve drying characteristics of the wet film. Plasticizers are used to minimize blistering, curl and delamination of cellulose acetate films during the drying operation. Preferably, plasticizers are added to the coating fluid at a total concentration of up to 50% by weight relative to the concentration of polymer in order to mitigate defects in the final cellulose acetate film.

Although not required, coating fluids for polycarbonates may also contain surfactants as coating aids to control artifacts related to flow after coating, similar to those previously described for use with PVB, and at similar distributions.

The LCD may also comprise at least one “functional layer” between the conductive layer and the substrate. The functional layer may comprise a protective layer or a barrier layer. The protective layer useful in the practice of the invention can be applied in any of a number of well known techniques, such as dip coating, rod coating, blade coating, air knife coating, gravure coating and reverse roll coating, extrusion coating, slide coating, curtain coating, and the like. The lubricant particles and the binder are preferably mixed together in a liquid medium to form a coating composition. The liquid medium may be a medium such as water or other aqueous solutions in which the hydrophilic colloid are dispersed with or without the presence of surfactants. A preferred barrier layer may acts as a gas barrier or a moisture barrier and may comprise SiOx, AlOx or ITO. The protective layer, for example, an acrylic hard coat, functions to prevent laser light from penetrating to functional layers between the protective layer and the substrate, thereby protecting both the barrier layer and the substrate. The functional layer may also serve as an adhesion promoter of the conductive layer to the substrate.

Other functional layers may comprise antireflection coatings, a thin dielectric* (electrical insulating) or metallic film, or several such films, applied to an optical surface to reduce its reflectance* (The ratio of reflected power to incident power, generally expressed in dB or percent.) and thereby increase its transmittance* (optical density). For minimum reflection* (The abrupt change in direction of a wave front at an interface between two dissimilar media so that the wave front returns into the medium from which it originated.) of a normal incident wave of a single wavelength* (The distance between points of corresponding phase of two consecutive cycles of a wave.), the antireflection coating may consist of a single layer and may desirably have (a) a refractive index* (Of a medium, the ratio of the velocity of propagation of an electromagnetic wave in vacuum to its velocity in the medium) equal to the square root of the refractive indices of the materials bounding the coating, and (b) a thickness equal to one-quarter the wavelength in question (that is, the wavelength within the material of which the coating consists). For minimum reflection of multiple wavelengths, additional layers may be added. (*Terms and definitions extracted verbatim from MIL-STD-2196 (SH), Glossary, Fiber Optics (1989).

Two terms used to talk about the impact of ambient lighting on displays are reflection and glare. The reduction of these is done using surface treatments for the display, which are termed antireflection and antiglare. Glare, as used herein, refers to a reflection from the display which is highly distracting. Typically a user will call an obvious reflection of a white shirt in a display as a glare which reduces his ability to perform his tasks. This is actually more correctly a specular reflection. Specular reflections are those we normally associate with a highly polished surface, such as a mirror. In technical terms, the angle of incidence of the light is equal to the angle of reflection of the light. Treatments of the surface to minimize this are referred to as antiglare or antireflection treatments. Antireflection treatments reduce the difference in refractive index between air and the display in a way which is the optical equivalent to impedance matching in electronics. Antiglare treatments, on the other hand, leave the impedance mismatch present, but cause the reflections to be scattered into all directions.

Antiglare properties are produced by roughening the surface of the display. This roughening can be done by any one of several processes: mechanical, chemical or depositions. Chemical or deposition processes are most commonly used for displays. In the chemical process, the glass or plastic overlay to be applied to the display is etched with an appropriate solvent; buffered hydrofluoric acid for glass or an organic solvent for plastic. This removes material in such a manner as to leave a microscopically roughened surface. Deposition processes involve spray or dip coating the overlay with a solution, which, on drying, will leave a roughened layer behind. A common method involves using a nano-particle suspension of SiO₂, which leaves behind a random distribution of particles when dried.

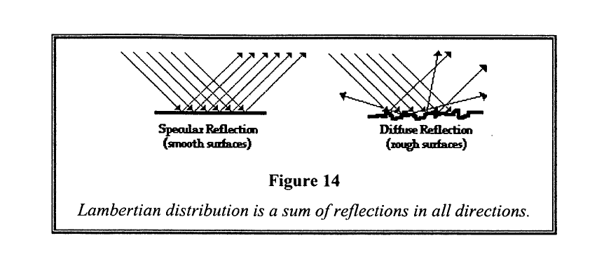

This surface treatment changes the ratio of specular to diffuse (Lambertian) reflections, illustrated in FIG. 14. The degree to which this occurs is measured by a glossmeter using standard test techniques such as ISO 2813, ASTM D 523, or DIN 67530. This instrument rates a surface in terms of percent of specular reflection; 92 gloss is a highly polished surface and 30 gloss is a very diffusely reflecting surface (approaching paper in appearance).

In contrast to antiglare treatments, antireflection films are all deposited onto a substrate. Careful design of the film involves specification of the refractive index of the glass or plastic and of the surrounding medium (typically air). With this information, the designer of the film can make a determination of which materials to use and the thickness to be deposited. Process control in production is obviously a key element, as well. These films can range from a simple, low cost single layer, typically made from magnesium fluoride, to higher performing, higher cost multiple layer deposition. These films are able to reduce the specular reflectance of a surface from the Fresnel value (about 4% for glass) to less than 0.5% over the visible range. More exotic coatings can be even lower.

Because of the difference in antiglare and antireflection surface treatments, it is possible to apply them independently or jointly to the display. The choice of treatments desirably takes careful account of the environment in which the display will be viewed. For locations, which have a few highly localized sources of light, a gloss of 60 with AR coating is recommended. In other applications where the light source is more diffuse (such as an outdoor kiosk), a more highly polished surface will generally be more desirable. The final choice can only be made by an on-site evaluation of displays with alternative finishes and under a variety of lighting conditions from full light to full nighttime brightness.

Antireflection layers or films may also be hard coatings to resist scratches and a vacuum deposited multilayer antireflection coating to reduce specular reflections to less than 0.75% over the entire visible spectrum. A protective fluorocarbon-based hydrophobic coating may be placed over the antireflection coating, which reduces the surface tension and resists environmental degradation from, for example, fingerprints and other surface contaminants. Additionally it may be desirable to provide the outer surface with resistance to chemicals and other environmental concerns. Displays are often in reach of people and can be soiled with a variety of materials including fingerprints, dirt, sticky materials and other materials. This may require that the outer view surface be cleaned. Such a surface may then be wiped and cleaned with acid and or basic type cleaners, soaps and other materials that can scratch the surface or leave deposits of cleaners on the surface. With time the displays will become less viewable and attractive in getting customers to notice.

In another embodiment, the polymeric support may further comprise an antistatic layer to manage unwanted charge build up on the sheet or web during roll conveyance or sheet finishing. In another embodiment of this invention, the antistatic layer has a surface resistivity of between 10⁵ to 10¹² ohms per square. Above 10¹², the antistatic layer typically does not provide sufficient conduction of charge to prevent charge accumulation to the point of preventing fog in photographic systems or from unwanted point switching in liquid crystal displays. While layers greater than 10⁵ will prevent charge buildup, most antistatic materials are inherently not that conductive and in those materials that are more conductive than 10⁵, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

In the formation of multi-colored displays, there are a large number of layers required to make the display function. This is evident by the figures shown above. It is known that when light travels from one layer to another, it is transmitted, absorbed and/or scattered. The relative amount of light that is scattered and transmitted is related to the refractive index difference between adjacent layers. The larger the difference in refractive index between the layers, the less efficient the display. In the construction described to make these displays, ITO is a common conducting material because of its optical transmission properties. ITO has a refractive index of from 1.8 to 2.0 and polythiophene has a refractive index of approximately 1.53. A base substrate, for example, polyester, has a refractive index of between 1.52-1.56, while the light modulating layer of liquid crystalline material has an average refractive index of approximately 1.6. In order to make a flexible display with an electrically modulated imaging layer of more than one imaging layer in which each of the imaging layers has a refractive index matched to the refractive index of the upper conductive layer and the refractive index of the lower conductive layer.

In another embodiment, the difference between the refractive index of the electrically modulated imaging layer and the refractive index of the upper conductive layer and the refractive index of the lower conductive layer is from 0.15 to 0.01. Such an embodiment is less scattering and will provide a display with improved viewability.

Another type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nano-pigments”. In a preferred embodiment, the dark layer absorbs all wavelengths of light across the visible light spectrum, that is from 400 nanometers to 700 nanometers wavelength. The dark layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine.

The functional layer may also comprise a dielectric insulating material. A dielectric insulating layer, for purposes of the present invention, is a layer that is not conductive or blocks the flow of electricity. This dielectric insulating material may include a UV curable, thermoplastic, screen printable material, such as Electrodag 25208 dielectric insulating coating from Acheson Corporation. The dielectric insulating material forms a dielectric insulating layer. This layer may include openings to define image areas, which are coincident with the openings. Since the image is viewed through a transparent substrate, the indicia are mirror imaged. The dielectric insulating material may form an adhesive layer to subsequently bond a second electrode to the light modulating layer.

When building displays, and in particular stacked display with more than one color, the overall thickness and the resulting stiffness of the display increases substantially. When improved flexibility is needed, it is desirable to have a means of building these displays with fewer layers. One means of doing this is to provide a transport/carrier substrate with a release layer that provides sufficient rigidity to allow the display to be conveyed through various coating and finishing processes but that can later be removed. This may be accomplished by providing a substrate that is coated with a release layer or layers of material(s) that has less adhesive or tack properties between the transport/carrier substrate and the release layer than adhesion of the display layers to the release layer or layers. Usually one needs to provide a balance of surface wetting properties between the transport/carrier sheet and the release layer as well as the layer that are coated on the release layer.

A method of making a flexible display using a transport/carrier web uses a polyester substrate. Other substrates may be used such as paper or polyethylene coated paper. The polyester transport/carrier base is corona treated to improve it wettability. A solution of polycarbonate is coated by applying a liquid polycarbonate/solvent mixture onto a moving substrate and drying the liquid polycarbonate/solvent mixture to substantially remove the solvent, yielding a composite of a polycarbonate release film (layer) adhered to a transport/carrier substrate. A layer of ITO at approximately 300 ohms/square may be sputtered coated onto the polycarbonate film layer in a vacuum coating process to form a lower or first conductive layer. The ITO layer may be etched into a series of parallel lines using a 355 nm laser. The ITO layer may be then coated with at least one light modulating layer, such as an aqueous dispersion of liquid crystal and gelatin binder, and the water removed in a hot air drying process. Another layer of ITO may be sputtered coated on top of the liquid crystal layer to form an upper or second conductive layer and then laser etched using a 355 nm laser with a series of parallel line at 90 degrees to the lines made in the first conductive layer. An insulating layer may be coated on top of the second conductive layer. A third layer of ITO may be sputtered coated onto the opposite side of the insulating layer from the second conductive layer and then etched on top of the insulating layer. Another layer of light modulating layer, preferably of a different color, may be coated and then dried on top the third conductive layer. A fourth layer of ITO may be sputtered coated on top of the second light modulating layer. The fourth conductive layer is then etched in a similar manner to the second conductive layer described above. Another insulating layer may be coated on top of the fourth etched ITO layer. A third set layer of display cell layers, preferably of yet another color, may be added to the display by coating a fifth layer of ITO, etching the ITO, coating and drying a third light modulating layer of a different color than the previous light modulating layers and then coating a sixth conductive layer, for example, of ITO or polythiophene, on top of the third light modulating layer. This conductive layer is then etched. A layer of light absorbing material may be coated on top of the sixth conductor to provide enhanced contrast to the display. Once the display has been completed, the transport web may be removed to provide a thin display that in flexible and has improved optical performance by eliminating the transport web. It should be noted that more than three colors may be used by coating additional layers of insulating layer-conductor-light modulating layer-conductor.

The above method may be broken into three separate steps by coating separate transport/carrier webs with a release layer, coating and etching the first conductive layer, coating and drying a light modulating layer thereon and then coating and etching a second (upper) conductive layer on top of the liquid crystal layer. If this process is repeated using different colors on separate transport substrates, the carrier substrate may be removed from each color and an electrically insulating adhesive used to adhere the different layers together. This step is useful because any problems incurred during one of the later coating processes have a reduced impact in terms of the cost of waste.

### EXAMPLES

The following examples are provided to illustrate the invention.

### Example 1

### Control

This example is shown in cross section in FIG. 1 in its laminated final form but was made from two separate webs (31 and 33) as shown by FIG. 2. Assembled display cell 33 was 125 micron, clear polyester substrate such as Dupont ST504 (11) and an ITO layer (13) of approximately 300 ohms/sq. The ITO was etched with a pulsed laser into a series of parallel line with approximately 3 mm spacing. The lines were in the machine direction of the web. The ITO was coated with an imageable layer containing gelatin and droplets of cholesteric liquid crystal as a separate web (31). A 4.7 mil clear polyester substrate (19) such as Dupont ST 504 was sputtered coated with a layer of ITO (17) in a vacuum deposited chamber. Such materials are commercially available from a number of ITO coaters such as Bekhart, CP Films, Sheldahl and Technimet. The ITO level was at approximately 300 ohms/sq. The ITO in web 31 was then etched with a pulsed laser with a series of parallel lines 90 degrees to the machine direction of the web. The two webs were heat laminated together in roll form to form a continuous web of switchable liquid crystal. A portion of the web from the roll was cut off and an electrical clip was attached to layers 13 and 17. A voltage was applied to switch the liquid crystal to a planar or focal conic state.

### Example 2

### Control

This example is shown in FIG. 4 and was made by forming three separate assembled display cells as described in example 1. The first assembled display cell was coated on a 125 micron clear polyester base with a imageable layer containing gelatin and droplets of blue cholesteric liquid crystal, the second assembled display cell was coated on a 125 micron clear polyester base with a imageable layer containing gelatin and droplets of green cholesteric liquid crystal and a third assembled display cell was coated on a 125 micron clear polyester base with a imageable layer containing gelatin and droplets of red cholesteric liquid crystal. Once the three assembled display cells were formed, they were adhered together by placing a strip of optically clear adhesive such as 3M 8142 (approximately 25 micron thick) between assembled display cells 1 and 2 and then between the second and third assembled display cell. Such a configuration forms a stacked three-color liquid assembled display cell. An electrical clip is attached to each ITO pair associate with each individual liquid color. Each color then can be switched independently.

### Example 3

This example (cross section shown in FIG. 5) was made similar to example 2 except layers 19c (top clear conductive layer) and 29 (black absorbing layer) were replaced with a printed layer patterned colored conductor, resulting in one less substrate as compared to Example 2. In this case a UV curable ink containing conductive carbon was patterned with a parallel line spacing. The layer had a conductivity of approximately 250 ohms/sq. This display had a minimum of 17 layers.

### Example 4

This example is shown by FIG. 6 and removes several substrate layers. In this example a 125 micron clear polyester substrate such as Dupont ST504 (11) was coated with an ITO layer (13) of approximately 300 ohms/sq. The ITO was etched with a pulsed laser into a series of parallel line with approximately 3 mm spacing. The lines were in the machine direction of the web. The ITO was coated with an imageable layer containing gelatin and droplets of blue cholesteric liquid crystal. Instead of laminating a second ITO bearing support as described in the above examples, the liquid crystal layer was vacuum coated with a layer of ITO at approximately 300 ohms/sq. to form a blue assembled display cell. The ITO deposited on the liquid crystal layer was directly laser-etched in place, as disclosed in U.S. Pat. No. 6,236,442, column 4 lines 16-50, incorporated herein by reference. These steps were repeated but in place of the blue liquid crystal, a green cholesteric liquid crystal material was coated to form a green assembled display cell. The procedure was repeated a third time with a red cholesteric coated in place of the blue one. The ITO coated onto the red liquid crystal layer was coated in turn with a color contrast layer containing gelatin and cyan, magenta, yellow, and black pigments to form a black layer. The blue and green assembled display cells were laminated together with a pressure sensitive adhesive (3M 8142) and the red assembled display cell was then laminated with the adhesive to the green side.

### Example 5

This example is shown in FIG. 7 and contained only 13 layers for a three color display and only had two substrates. This example was made the same as Example 4 for the blue and green assembled display cells. The red assembled display cell was made by screen printing a 125 micron black polyester substrate with a black UV curable carbon conductor with a conductivity of approx. 250 ohms/sq. The black conductor was patterned and then coated with an imageable layer containing gelatin and droplets of red cholesteric liquid crystal. The three assembled display cells described were then adhesive laminated together with an optically clear adhesive (3M 8142). Since the substrate was behind the black conductor and therefore the furthest from the viewer, it was not consider to be in the active view plane of this display.

### Example 6

This example is shown in FIG. 8 and contained only 11 layers in the active view plane of the display. In this example, there was only one substrate layer in the display, even though it still contains three colors. This example was made by forming two assembled display cells and laminating them together. In this case, a 125 micron layer of polyester was coated with a 300 ohms/sq. layer of ITO on both sides. One side of the ITO was then coated with an imageable layer, containing gelatin, hardener and droplets of blue cholesteric liquid crystal. The opposite ITO side was coated with an imageable layer containing gelatin and hardener and droplets of green cholesteric liquid crystal. A coating layer of polythiophene with a crosslinked silane was then coated on top of the green and blue liquid crystal. The red assembled display cell was made by screen printing a 125 micron black polyester substrate with a black UV curable carbon conductor with a conductivity of approx. 250 ohms/sq. The black conductor was patterned and then coated with an imageable layer containing gelatin and droplets of red cholesteric liquid crystal. The two assembled display cells described were then adhesively laminated together with an optically clear Adhesive (3M 8142). Since the substrate was behind the black conductor and therefore the furthest from the viewer, it was not consider to be in the active view plane of this display.

### Example 7

This display example is shown by FIG. 9 and contains only one substrate. A 125 micron clear polyester substrate (11a) is coated with a layer of ITO at 300 ohms/sq. (13a). An imageable layer containing gelatin and hardener and droplets of blue cholesteric liquid crystal (15) is coated on top of the layer 31a (ITO) A second layer of ITO (17a) is coated on top of the liquid crystal layer. A dielectric insulating layer (41a) of approximately 10 microns of a polyurethane (Sancure 898, available from Noveon) is coated and dried. A third layer of ITO (13b) is coated on top of a corona treated polyurethane layer. An imageable layer containing gelatin and hardener and droplets of green cholesteric liquid crystal (27) is coated on top of the polythiophene. A fourth layer of ITO (I 7b) is coated on top of the liquid layer. A dielectric insulating layer (41b) of approximately 10 microns of a polyurethane (Sancure 898, available from Noveon) is coated and dried. A fifth layer of ITO (17c) is coated on top of a corona treated polyurethane layer. An imageable layer containing gelatin and hardener and droplets of red cholesteric liquid crystal (25) is coated on top of the ITO. A sixth layer of ITO (17c) is coated on to of the liquid crystal layer. A layer with a color contrasting layer containing gelatin and cyan, magenta, yellow, and black pigments to form a black layer is then applied to the last conductor.

### Example 8

While this example is also shown in cross section in FIG. 10, the example is built in a similar manner as example 7 (FIG. 9) except the layers 17c and 19 are replaced by a single layer 55 thus eliminating one layer of ITO and thereby decreasing the amount of scattering from the eliminated interlayer interface, and increasing the efficiency.

### Example 9

This example is shown in FIG. 11 and contains no substrates and only has eleven or twelve layers in the active display. The display is coated on a 125 micron polyester black substrate (35) that is screen printed with a black patterned conductor (55) using a carbon filled UV curable acrylate ink with a conductivity of approximately 250 ohms/sq. An imageable layer containing gelatin and hardener and droplets of red cholesteric liquid crystal (25) is coated on top of the black patterned conductor. A layer of ITO (13c) is coated to approximately 300 ohms/sq conductivity. A dielectric insulating layer (41b) is coated using approximately 10 microns of Sancure polyurethane. A layer of ITO (17b) at 300 ohms/sq. is coated on the dielectric insulating layer. An imageable layer containing gelatin and hardener and droplets of green cholesteric liquid crystal (27) is coated on top of the ITO. Another layer of ITO is then applied on to the green liquid crystal layer (13b). Another dielectric insulating layer (41a) with the same composition as 41b is coated onto the ITO layer (13b). A layer of ITO is then sputtered coated on top of the dielectric insulating layer. An imageable layer containing gelatin and hardener and droplets of blue cholesteric liquid crystal (I 5) is applied. A final layer of ITO is then applied to the blue liquid crystal layer. This display is viewed from the opposite side of the substrate. The substrate may or may not be in the active view plane of the display.

### Example 10

This example is also shown in FIG. 11 and contains no substrates and only has eleven layers in the active display. The display is coated on a 125 micron polyester black substrate (35) that is screen printed with a black patterned conductor (55) using a carbon filled UV curable acrylate ink with a conductivity of approximately 250 ohms/sq. An imageable layer containing gelatin and hardener and droplets of red cholesteric liquid crystal (25) is coated on top of the black patterned conductor. A layer of polythiophene (13c) is coated to a thickness that yields approximately 300 ohms/sq. conductivity and then patterned using a pulsed 355 nm UV laser. It should be noted that ITO could be used in place of the polythiophene. A dielectric insulating layer (41b) is coated using approximately 10 microns of Sancure polyurethane. A layer of ITO (17b) at 300 ohms/sq. is coated on the dielectric insulating layer. An imageable layer containing gelatin and hardener and droplets of green cholesteric liquid crystal (27) is coated on top of the ITO. Another layer of ITO is then applied on to the green liquid crystal layer (13b). Another dielectric insulating layer (41a) with the same composition as 41b is coated on ITO layer (13b). A layer of ITO is then sputtered coated on to of the dielectric insulating layer. An imageable layer containing gelatin and hardener and droplets of blue cholesteric liquid crystal (15) is next applied. A final layer of ITO is then applied to the blue liquid crystal layer. This display is viewed from the opposite side of the substrate. The substrate is not in the active view plane of the display.

### Example 11

This example is yet another means of building a three-color display. This example is made in two parts as shown by FIGS. 12 and 13. This example contains no substrates and has twelve layers. This display is made in a similar manner to example 10 except that the substrate is replaced with a transport sheet that was coated with a release layer of acetate. After the display is built the release layer can be separated from the transport sheet.

TABLE 1

| | | # of | # of | Relative Haze |
|---|---|---|---|---|
| Example | FIG. | Substrates | Layers | Perception |
| 2 (control) | 4 | 6 | 18 | 10 |
| 3 (inventive) | 5 | 5 | 17 | 9 |
| 4 (inventive) | 6 | 3 | 15 | 8 |
| 5 (inventive) | 7 | 2 | 13 | 7 |
| 6 (inventive) | 8 | 1 | 11 | 4 |
| 7 (inventive) | 9 | 1 | 13 | 6 |
| 8 (inventive) | 10 | 1 | 12 | 5 |
| 9 (inventive) | 11 | 0 | 11 | 1* |
| 10 (inventive) | 11 | 0 | 11 | 3* |
| 11 (inventive) | 12 & 13 | 0 | 12 | 2 |
| *Examples 9 and 10 are different in that example 9 is made with all ITO conductors while example 10 is made with a combination of polythiophene and ITO conductors. Because polythiophene is more light absorbing than ITO it results in more light loss than ITO in a stacked display. In example 10, the | | | | |
| # polythiophene is placed in the layers furthest from the viewing side. This helps to minimize light loss. | | | | |

In this ranking for perception, the haze referred to is the perceived milkiness of the surface color as observed. A relative ranking is given to the samples based on general observations based on the number of highly scattering interfaces and refractive index steps.

As can be seen from the data contained in Table 1, there are a number of ways to build a multi-colored switchable light modulating displays with reduced number of layers and substrates. As can be seen, the relative performance improves with fewer layers.

Variations of the above examples may include but are not limited to the substitution of polythiophene for ITO at or near the same conductivity. Other variations may include combinations of ITO on some liquid crystals and Polythiophene on others or even having ITO as either the top or bottom conductive layer and polythiophene as the opposite conductor for the same liquid crystal layer.

The invention has been described in detail with particular reference to certain preferred embodiments thereof, but it will be understood that variations and modifications can be effected within the spirit and scope of the invention.

1. A flexible multi-color display comprising an optional substrate, at least one independently switchable electrically modulated imaging layer between an upper conductive layer and a lower conductive layer, wherein the number of said optional substrate is less than or equal to the number of said at least one independently switchable electrically modulated imaging layer.

2. The display of claim 1 wherein said substrate is transparent.

3. The display of claim 2 wherein said transparent substrate comprises polyester.

4. The display of claim 2 wherein said transparent substrate comprises polycarbonate.

5. The display of claim 2 wherein said transparent substrate comprises polyethylene naphthalate (PEN).

6. The display of claim 2 wherein said transparent substrate comprises acetate.

7. The display of claim 2 wherein said transparent substrate comprises polyethersulfone.

8. The display of claim 2 wherein said transparent substrate comprises at least one member selected from the group consisting of polyolefin, polyester, polycarbonate, acetate, cyclic polyolefin, polyethersulfone, and polyamide.

9. The display of claim 1 wherein said substrate is removable.

10. The display of claim 9 wherein said removable substrate further comprises at least one adhesion modifying layer.

11. The display of claim 10 wherein said adhesion modifying layer is a release layer.

12. The display of claim 10 wherein said adhesion modifying layer has an adhesive strength of less than 250 N/m.

13. The display of claim 12 wherein the adhesion between the first-pass film and the transport substrate is greater than 0.3 N/m.

14. The display of claim 10 wherein said removable substrate comprises at least one member selected from the group consisting of polyester, polycarbonate, polyolefin, acetate, and paper.

15. The display of claim 11 wherein said release layer comprises an acetate film.

16. The display of claim 15 wherein said acetate film comprises cellulose ester.

17. The display of claim 11 wherein said release layer comprises a polyvinyl butyral film.

18. The display of claim 17 wherein the adhesion between the polyvinyl butyral film and the transport substrate is less than 250 N/m.

19. The display of claim 11 wherein said release layer comprises polycarbonate film.

20. The display of claim 19 wherein the adhesion between said polycarbonate film and the transport substrate is from 0.5 to 25 N/m.

21. The display of claim 11 wherein said at least one adhesion modifying layer comprises an adhesive layer.

22. The display of claim 21 wherein said adhesive layer is optically clear.

23. The display of claim 1 wherein said electrically modulated imaging layer comprises a light modulating material.

24. The display of claim 23 wherein said light modulating material comprises a liquid crystal material.

25. The display of claim 24 wherein said liquid crystal material is a chiral nematic liquid crystal material.

26. The display of claim 24 wherein said liquid crystal material is a polymer dispersed cholesteric liquid crystal layer.

27. The display of claim 26 wherein said polymer is gelatin.

28. The display of claim 26 wherein said polymer is polyvinyl alcohol.

29. The display of claim 26 wherein said polymer is latex.

30. The display of claim 26 wherein said polymer is water soluble.

31. The display of claim 26 wherein said polymer dispersed cholesteric liquid crystal layer further comprises a hardener.

32. The display of claim 1 wherein said electrically modulated imaging layer comprises electrochromic materials.

33. The display of claim 1 wherein said electrically modulated imaging layer comprises more than one imaging layer and wherein each of said electrically modulated imaging layers has a refractive index and said refractive index of each of said electrically modulated imaging layers is matched to the refractive index of said upper conductive layer and the refractive index of said lower conductive layer.

34. The display of claim 33 wherein the difference between said refractive index of said electrically modulated imaging layer and said refractive index of said upper conductive layer and said refractive index of said lower conductive layer is from 0.15 to 0.01.

35. The display of claim 1 wherein said at least one independently switchable electrically modulated imaging layer between an upper conductive layer and a lower conductive layer comprises a blue independently switchable liquid crystal layer, a green independently switchable liquid crystal layer and a red independently switchable liquid crystal layer.

36. The display of claim 1 wherein said at least one of said upper conductive layer and said lower conductive layer is patterned to form a regular grid pattern.

37. The display of claim 1 wherein at least one of said upper conductive layer and said lower conductive layer comprises ITO.

38. The display of claim 1 wherein said at least one of said upper conductive layer and said lower conductive layer comprises polythiphene

39. The display of claim 38 wherein said polythiophene is combined with a crosslinked silane

40. The display of claim 1 wherein at least one of said upper conductive layer and said lower conductive layer comprise a transparent conductive material.

41. The display of claim 40 wherein said transparent conductive material comprises a material transparent to visible light in the range from 400 to 700 nm.

42. The display of claim 40 wherein said transparent conductive material has a percent transmission of between 80 and 95% across the visible spectrum.

43. The display of claim 1 wherein said upper conductive layer is a black-colored conductive layer.

44. The display of claim 43 wherein said black-colored conductive layer comprises a black UV curable carbon conductor.

45. The display of claim 43 wherein said black-colored conductive layer
is a color contrasting layer containing gelatin and cyan, magenta, yellow, and black pigments to form a black layer.

46. The display of claim 1 further comprising an environmental protection layer.

47. The display of claim 1 further comprising a dielectric insulating layer.

48. The display of claim 1 wherein said display further comprises a radiation absorbing layer.

49. The display of claim 48 wherein said radiation absorbing layer is a color contrast layer.

50. The display of claim 49 wherein said color contrast layer comprises gelatin and cyan, magenta, yellow, and black pigments to form a black layer.

51. The display of claim 1 wherein said display further comprises an antistatic layer.

52. The display of claim 1 wherein said display further comprises at least one antireflection coating.

53. The display of claim 52 wherein said antireflection coating comprises at least one thin dielectric or metallic film.

54. The display of claim 52 wherein said antireflection coating comprises magnesium fluoride.

55. The display of claim 52 wherein said antireflection coating has a Fresnel value of less than 0.5% over the visible range.

56. The display of claim 52 wherein said antireflection coating has a surface reflection from 400-800 nm of less than 1%.

57. The display of claim 1 further comprising a layer having an antiglare treated surface closest to the viewer.

58. The display of claim 57 wherein said antiglare treated surface is a roughened surface.

59. The display of claim 58 wherein said roughened layer comprises nano-particles of SiO₂.

60. The display of claim 57 wherein said layer having an antiglare treated surface comprises a glass or plastic overlay etched with a solvent.

61. The display of claim 57 wherein said layer having an antiglare treated surface comprises glass etched with buffered hydrofluoric acid.

62. The display of claim 57 wherein said layer having an antiglare treated surface comprises plastic etched with organic solvent.

63. A display comprising a top part having an upper and lower layer and a bottom part having an upper and lower layer, wherein said lower layer of said top part and said upper layer of said bottom part are laminated together, wherein said top part comprises an upper substrate layer and a lower conductive layer and wherein said bottom part comprises an upper liquid crystal layer, a lower transparent substrate layer, and a conductive layer between said upper liquid crystal layer and said lower transparent substrate layer.

64. The display of claim 63 wherein said upper substrate is a black polyester substrate.

65. The display of claim 63 wherein said upper substrate is a transport sheet as coated with a release layer of acetate.

66. The display of claim 63 wherein said substrate is transparent.

67. The display of claim 66 wherein said transparent substrate comprises at least one member selected from the group consisting of polyolefin, polyester, polycarbonate, acetate, cyclic polyolefin, polyethersulfone, and polyamide.

68. The display of claim 63 wherein said substrate is removable.

69. The display of claim 68 wherein said removable substrate further comprises at least one adhesion modifying layer.

70. The display of claim 69 wherein said adhesion modifying layer is a release layer.

71. The display of claim 69 wherein said adhesion modifying layer has an adhesive strength of less than 250 N/m.

72. The display of claim 71 wherein the adhesion between the first-pass film and the transport substrate is greater than 0.3 N/m.

73. The display of claim 69 wherein said removable substrate comprises at least one member selected from the group consisting of polyester, polycarbonate, polyolefin, acetate, and paper.

74. The display of claim 70 wherein said release layer comprises an acetate film.

75. The display of claim 70 wherein said release layer comprises a polyvinyl butyral film.

76. The display of claim 70 wherein said release layer comprises polycarbonate film.

77. The display of claim 70 wherein said at least one adhesion modifying layer comprises an adhesive layer.

78. The display of claim 63 wherein said electrically modulated imaging layer comprises a light modulating material.

79. The display of claim 78 wherein said light modulating material comprises a liquid crystal material.

80. The display of claim 79 wherein said liquid crystal material is a chiral nematic liquid crystal material.

81. The display of claim 79 wherein said liquid crystal material is a polymer dispersed cholesteric liquid crystal layer.

82. The display of claim 81 wherein said polymer dispersed cholesteric liquid crystal layer further comprises a hardener.

83. The display of claim 63 wherein said electrically modulated imaging layer comprises electrochromic materials.

84. The display of claim 63 wherein said electrically modulated imaging layer comprises more than one imaging layer and wherein each of said electrically modulated imaging layers has a refractive index and said refractive index of each of said electrically modulated imaging layers is matched to the refractive index of said upper conductive layer and the refractive index of said lower conductive layer.

85. The display of claim 84 wherein the difference between said refractive index of said electrically modulated imaging layer and said refractive index of said upper conductive layer and said refractive index of said lower conductive layer is from 0.15 to 0.01.

86. The display of claim 63 wherein said at least one independently switchable electrically modulated imaging layer between an upper conductive layer and a lower conductive layer comprises a blue independently switchable liquid crystal layer, a green independently switchable liquid crystal layer and a red independently switchable liquid crystal layer.

87. The display of claim 63 wherein said at least one of said upper conductive layer and said lower conductive layer is patterned to form a regular grid pattern.

88. The display of claim 63 wherein at least one of said upper conductive layer and said lower conductive layer comprise a transparent conductive material.

89. The display of claim 63 wherein said upper conductive layer is a black-colored conductive layer.

90. The display of claim 63 further comprising a functional layer.

91. The display of claim 90 wherein said laminated layers are laminated by means of an adhering material positioned therebetween.

92. The display of claim 91 wherein said adhering material is optically clear.

93. The display of claim 63 wherein said bottom part comprises an upper first conductive layer, a lower substrate layer of said bottom part, a liquid crystal layer of said bottom part therebetween, and a second conductive layer between said lower substrate layer of said bottom part and said liquid crystal layer of said bottom part, wherein said top part comprises an upper third conductive layer of said top part, a lower substrate layer of said top part, a liquid crystal layer of said top part therebetween, and a fourth conductive layer between said lower substrate layer of said top part and said liquid crystal layer of said top part, and further comprising a middle part having an upper fifth conductive layer of said middle part, a lower substrate layer of said middle part, a liquid crystal layer of said middle part therebetween, and a sixth conductive layer between said lower substrate layer of said middle part and said liquid crystal layer of said middle part, and wherein said lower layer of said top part is laminated to said upper layer of said middle part and said lower layer of said middle part is laminated to said upper layer of said bottom part.

94. The display of claim 93 wherein said liquid crystal layer of said top part is red, said liquid crystal layer of said middle part is green, and said liquid crystal layer of said bottom part is blue.

95. The display of claim 93 wherein said conductive layers are patterned conductive layers.

96. The display of claim 93 wherein at least one of said conductive layers comprises polythiophene.

97. The display of claim 93 wherein at least one of said conductive layers comprises ITO.

98. The display of claim 93 wherein said laminated layers are laminated by means of an adhering material positioned therebetween.

99. The display of claim 98 wherein said adhering material is optically clear.

100. The display of claim 93 wherein said upper substrate layer of said top part further comprises a black-colored absorbing layer opposite said first conductive layer.

101. The display of claim 100 wherein said black-colored absorbing layer is a color contrasting layer containing gelatin and cyan, magenta, yellow, and black pigments to form a black layer.

102. The display of claim 93 wherein said third conductive layer is an etched or printed black conductive layer.

103. The display of claim 102 wherein said etched or printed black conductive layer is a black UV curable carbon conductor

104. The display of claim 63 wherein said bottom part comprises a lower substrate layer of said bottom part, an upper first conductive layer of said bottom part, a liquid crystal layer of said bottom part therebetween, and a second conductive layer between said lower substrate layer of said bottom part and said liquid crystal layer of said bottom part, wherein said top part comprises an upper black-colored absorbing layer of said top part, a lower substrate layer of said top part, a liquid crystal layer of said top part therebetween, a third conductive layer between said upper black-colored absorbing layer of said top part and said liquid crystal layer of said top part and a fourth conductive layer between said lower substrate layer of said top part and said liquid crystal layer of said top part, and further comprising a middle part having an upper fifth conductive layer of said middle part, a lower substrate layer of said middle part, a liquid crystal layer of said middle part therebetween, and a sixth conductive layer between said lower substrate layer of said middle part and said liquid crystal layer of said middle part, and wherein said lower layer of said top part is laminated by means of an adhesive layer to said upper layer of said middle part and said lower layer of said middle part is laminated by means of an adhesive layer to said upper layer of said bottom part.

105. The display of claim 104 wherein said upper black-colored absorbing layer of said top part further comprises a black-colored substrate layer opposite said third conductive layer.

106. The display of claim 63 wherein bottom part comprises an upper transparent substrate of said bottom part, a lower etched first conductive layer of said bottom part, a liquid crystal layer of said bottom part therebetween, and a second conductive layer of said bottom part between said upper substrate of said bottom part, and said liquid crystal layer of said bottom part, wherein said top part comprises an upper black third conductive layer of said top part, a lower fourth conductive layer of said top part, a liquid crystal layer of said top part therebetween, and further comprising a middle part having an upper substrate layer of said middle part, a lower fifth conductive layer of said middle part, a liquid crystal layer of said middle part therebetween, and a sixth conductive layer between said upper substrate layer of said middle part and said liquid crystal layer of said middle part, and wherein said lower layer of said top part is laminated by means of an adhesive layer to said upper layer of said middle part and said lower layer of said middle part is laminated by means of an adhesive layer to said upper layer of said bottom part.

107. The display of claim 106 wherein said upper black third conductive layer of said top part further comprises a black-colored substrate layer opposite said liquid crystal layer of said top part.

108. The display of claim 63 wherein said top part comprises an upper black first conductive layer of said top part, a lower second conductive layer of said top part, and a liquid crystal layer of said top part therebetween and a bottom part comprising an upper third conductive layer of said bottom part, a lower fourth conductive layer of said bottom part, a substrate layer of said bottom part between said upper third conductive layer of said bottom part and said lower fourth conductive layer of said bottom part, wherein said substrate layer of said bottom part has a side bearing a fifth conductive layer and a side bearing a sixth conductive layer, a liquid crystal layer of said bottom part between said lower fourth conductive layer of said bottom part and said sixth conductive layer and a liquid crystal layer of said bottom part between said upper third conductive layer of said bottom part and said fifth conductive layer, wherein said lower layer of said top part and said upper layer of said bottom part are laminated by means of an adhesive layer.

109. The display of claim 63 wherein said bottom part comprises an upper first conductive layer, a lower substrate layer of said bottom part, a liquid crystal layer of said bottom part therebetween, and a second conductive layer between said lower substrate layer of said bottom part and said liquid crystal layer of said bottom part, wherein said top part comprises an upper third conductive layer of said top part, a lower dielectric insulating layer of said top part, a liquid crystal layer of said top part therebetween, and a fourth conductive layer between said lower substrate layer of said top part and said liquid crystal layer of said top part, and further comprising a middle part having an upper fifth conductive layer of said middle part, a lower dielectric insulating layer of said middle part, a liquid crystal layer of said middle part therebetween, and a sixth conductive layer between said lower substrate layer of said middle part and said liquid crystal layer of said middle part, and wherein said lower layer of said top part is laminated to said upper layer of said middle part and said lower layer of said middle part is laminated to said upper layer of said bottom part.

110. The display of claim 109 wherein said dielectric insulating layer comprises polyurethane.

111. The display of claim 109 wherein said lower substrate layer of said bottom part comprises a transport sheet.

112. The display of claim 111 wherein said transport sheet comprises a sheet bearing a layer of clear polymer, wherein said layer of clear polymer has poor adhesion to said sheet, and wherein said layer of clear polymer serves as the separation interface between said sheet and said liquid crystal layer of said bottom part.

113. A coated display comprising at least one coated liquid crystal assembled display cell, wherein said liquid crystal assembled display cell comprises a coated transparent conductive layer, a black etched conductor coated onto a substrate that is not in the active view plane of the display, and a liquid crystal layer coated between said transparent conductive layer and said black etched conductor.

114. A coated display comprising a substrate that is not in the active view plane of the display, a black conductive layer coated thereon, a third liquid crystal layer coated on the side of said black conductive layer opposite said substrate, a fifth conductive layer coated on the side of said third liquid crystal layer opposite said black conductive layer, a second dielectric insulating layer coated on the side of said fifth conductive layer opposite said third liquid crystal layer, a fourth conductive layer coated on the side of said second dielectric insulating layer opposite said fifth conductive layer, a second liquid crystal layer coated on the side of said fourth conductive layer opposite said second dielectric insulating layer, a third conductive layer coated on the side of said second liquid crystal layer opposite said fourth conductive layer, a first dielectric insulating layer coated on the side of said third conductive layer opposite said second liquid crystal layer, a second conductive layer coated on the side of said first dielectric insulating layer opposite said third conductive layer, a first liquid crystal layer coated on the side of said second conductive layer opposite said first dielectric insulating layer, and a first conductive layer coated on the side of said first liquid crystal layer opposite said second conductive layer.

115. A method of forming a flexible multi-color display comprising providing a removable substrate; and applying at least one independently switchable light modulating layer between an upper conductive layer and a lower conductive layer, wherein the number of said at least one substrate is less than or equal to the number of said at least one modulating layer.

116. The method of claim 115 wherein said applying comprises coating.

117. The method of claim 115 wherein said removable film comprises polyvinyl butyral.

118. The method of claim 115 wherein said providing a removable film comprises coating polyvinyl butyral (PVB) resin dissolved in at least one organic solvent.

119. The method of claim 118 wherein said organic solvent further comprises plasticizer or surfactant.

120. The method of claim 115 wherein said removable film comprises polycarbonate film.

121. The method of claim 115 wherein said providing a removable film comprises coating a polycarbonate resin dissolved in an organic solvent.

122. The method of claim 121 wherein said organic solvent further comprises plasticizer or surfactant.

123. The method of claim 115 wherein said removable film comprises an acetate film.

124. The method of claim 115 wherein said providing a removable film comprises coating a cellulose ester dissolved in at least one organic solvent.

125. The method of claim 124 wherein said organic solvent further comprises plasticizer or surfactant.

126. The method of claim 115 further comprising removing said removable substrate.

127. A method of forming a flexible multi-color display comprising providing a substrate and applying an upper patterned conductive layer thereto to form an upper display portion; providing a transparent substrate and applying a lower patterned conductive layer followed by an electrically modulate imaging layer thereto to form a lower display portion; and laminating said upper display portion to said lower display portion.
